(19) United States
(12) Patent Application Publication
(10) Pub. No.: US 2025/0373392 A1
(43) Pub. Date: Dec. 4, 2025

(54) METHOD AND APPARATUS FOR ESTIMATING FREQUENCY OFFSET OF REFERENCE SIGNAL IN WIRELESS COMMUNICATION SYSTEM

(71) Applicant: Samsung Electronics Co., Ltd., Suwon-si (KR)

(72) Inventors: Youngtaek BAE, Suwon-si (KR); Jinwhan KANG, Suwon-si (KR); Hayoung YANG, Suwon-si (KR); Joohyun LEE, Suwon-si (KR)

(21) Appl. No.: 19/299,955

(22) Filed: Aug. 14, 2025

Related U.S. Application Data
(63) Continuation of application No. PCT/KR2023/016222, filed on Oct. 19, 2023.

(30) Foreign Application Priority Data
Feb. 15, 2023 (KR) 10-2023-0020388

(51) Int. Cl. H04L 5/00

(52) U.S. Cl. CPC H04L 5/005; H04L 5/0094

(57) ABSTRACT

A method performed by a reception device in a wireless communication system is provided. The method includes generating one or more first sets by selecting three symbols in one slot, the three symbols corresponding to a first symbol, a second symbol and a third symbol, respectively, in an ascending order, for each of the one or more first sets, calculating an estimation range of a frequency offset, based on a first distance corresponding to a time interval between the first symbol and the second symbol and a second distance corresponding to a time interval between the second symbol and the third symbol, identifying, from among the one or more first sets, one or more second sets in which the calculated estimation range of the frequency offset is greatest, and transmitting a signal by arranging a reference signal (RS) symbols for one of the one or more second sets.

### CROSS-REFERENCE TO RELATED APPLICATION(S)

This application is a continuation application, claiming priority under 35 U.S.C. § 365(c), of an International application No. PCT/KR2023/016222, filed on Oct. 19, 2023, which is based on and claims the benefit of a Korean patent application number 10-2023-0020388, filed on Feb. 15, 2023, in the Korean Intellectual Property Office, the disclosure of which is incorporated by reference herein in its entirety.

### BACKGROUND

### 1. Field

The disclosure relates to a wireless communication system. More particularly, the disclosure relates to a method and an apparatus for estimating a frequency offset of a reference signal in a wireless communication system.

### 2. Description of Related Art

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a “beyond 4G network” communication system or a “post long term evolution (post LTE)” system.

The 5G communication system is considered to be implemented in ultrahigh frequency (mmWave) bands, (e.g., 60 GHz bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (CoMPs), reception-end interference cancellation, and the like.

I In the 5G system, hybrid frequency shift keying (FSK) and quadrature amplitude modulation (QAM) (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a procedure of estimating a frequency offset of a reference signal in a wireless communication system.

Additional aspects will be set forth in part in the description which follows and, in part, will be apparent from the description, or may be learned by practice of the presented embodiments.

In accordance with an aspect of the disclosure, a method performed by a transmission device in a wireless communication system is provided. The method includes generating one or more first sets by selecting three symbols in one slot, the three symbols corresponding to a first symbol, a second symbol, and a third symbol, respectively, in an ascending order, for each of the one or more first sets, calculating, an estimation range of a frequency offset, based on a first distance corresponding to a time interval between the first symbol and the second symbol and a second distance corresponding to a time interval between the second symbol and the third symbol, identifying, from among the one or more first sets, one or more second sets in which the calculated estimation range of the frequency offset is greatest and transmitting a signal by arranging reference signal (RS) symbols for one of the one or more second sets.

In accordance with another aspect of the disclosure, a method performed by a reception device in a wireless communication system is provided. The method includes receiving a signal including three reference signal (RS) symbols in one slot, the three RS symbols corresponding to a first RS symbol, a second RS symbol, and a third RS symbol, respectively, in an ascending order, and based on a first distance corresponding to a time interval between the first RS symbol and the second RS symbol and a second distance corresponding to a time interval between the second RS symbol and the third RS symbol, calculating an estimation range of a frequency offset.

In accordance with another aspect of the disclosure, a transmission device in a wireless communication system is provided. The transmission device includes communication circuitry, memory, comprising one or more storage media, storing instructions and one or more processors communicatively coupled to the communication circuitry, wherein the instructions, when executed by the one or more processors individually or collectively, cause the transmission device to generate one or more first sets by selecting three symbols in one slot, the three symbols corresponding to a first symbol, a second symbol, and a third symbol, respectively, in an ascending order, for each of the one or more first sets, calculate an estimation range of a frequency offset, based on a first distance corresponding to a time interval between the first symbol and the second symbol and a second distance corresponding to a time interval between the second symbol and the third symbol, identify, from among the one or more first sets, one or more second sets in which the calculated estimation range of the frequency offset is greatest, and transmit a signal by arranging reference signal (RS) symbols for one of the one or more second sets.

In accordance with another aspect of the disclosure, a reception device in a wireless communication system is provided. The reception device includes communication circuitry, memory, comprising one or more storage media, storing instructions, and one or more processors communicatively coupled to the communication circuitry and the memory, wherein the instructions, when executed by the one or more processors individually or collectively, cause the reception device to receive a signal including three reference signal (RS) symbols in one slot, the three RS symbols corresponding to a first RS symbol, a second RS symbol, and a third RS symbol, respectively, in an ascending order, and based on a first distance corresponding to a time interval between the first RS symbol and the second RS symbol and a second distance corresponding to a time interval between the second RS symbol and the third RS symbol, calculate an estimation range of a frequency offset.

In accordance with another aspect of the disclosure, one or more non-transitory computer-readable storage media storing one or more computer programs including computer-executable instructions that, when executed by one or more processors of a transmission device in a wireless communication system individually or collectively, cause the transmission device to perform operations are provided. The operations include generating one or more first sets by selecting three symbols in one slot, the three symbols corresponding to a first symbol, a second symbol, and a third symbol, respectively, in an ascending order, for each of the one or more first sets, calculating an estimation range of a frequency offset, based on a first distance corresponding to a time interval between the first symbol and the second symbol and a second distance corresponding to a time interval between the second symbol and the third symbol, identifying, from among the one or more first sets, one or more second sets in which the calculated estimation range of the frequency offset is greatest, and transmitting a signal by arranging reference signal (RS) symbols for one of the one or more second sets.

According to various embodiments of the disclosure, a procedure of estimating a frequency offset of a reference signal in a wireless communication system can be efficiently improved.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 illustrates a transmission device in a wireless communication system according to an embodiment of the disclosure;

FIG. 3 illustrates a reception device in a wireless communication system according to an embodiment of the disclosure;

FIG. 4 is a view illustrating estimation of a frequency offset by a transmission device in a wireless communication system according to an embodiment of the disclosure;

FIG. 5 is another view illustrating estimation of a frequency offset by a transmission device in a wireless communication system according to an embodiment of the disclosure;

FIG. 6 is a flowchart illustrating extraction of a symbol combination for estimating a frequency offset by a transmission device in a wireless communication system according to an embodiment of the disclosure;

FIG. 7 is a flowchart illustrating estimation of a frequency offset by a transmission device in a wireless communication system according to an embodiment of the disclosure; and

FIG. 8 is a flowchart illustrating estimation of a frequency offset by a reception device in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, various embodiments of the disclosure will be described based on an approach of hardware. However, various embodiments of the disclosure include a technology that uses both hardware and software, and thus the various embodiments of the disclosure may not exclude the perspective of software.

Furthermore, various embodiments of the disclosure will be described using terms used in some communication standards (e.g., the 3rd generation partnership project (3GPP)), but they are for illustrative purposes only. Various embodiments of the disclosure may also be easily applied to other communication systems through modifications.

In the following description, terms referring to signals (e.g., message, signal, signaling, sequence, and streams), terms referring to resources (e.g., symbol, slot, subframe, radio frame (RF), subcarrier, resource element (RE), resource block (RB), bandwidth part (BWP), and occasion), terms for operations (e.g., step, method, process, and procedure), terms referring to data (e.g., information, parameter, variable, value, bit, symbol, and codeword), terms referring to channels, terms referring to control information (e.g., downlink control information (DCI), medium access control codeword element (MAC CE), and radio access control (RRC) signaling), terms referring to network entities, terms referring to device elements, and the like are illustratively used for the sake of descriptive convenience. Therefore, the disclosure is not limited by the terms as described below, and other terms referring to subjects having equivalent technical meanings may be used.

Various aspects are described herein in connection with a wireless terminal and/or a base station. A wireless terminal may refer to a device providing voice and/or data connectivity to a user. The wireless terminal may be connected to aa computing device such a laptop computer or desktop computer. The wireless terminal may also be called a system, a subscriber unit, a subscriber station, mobile station, mobile, remote station, access point, remote terminal, access terminal, user terminal, user agent, user device, or user equipment. The wireless terminal may be a subscriber station, a wireless device, a cellular phone, a portable device having radio access capability, or any other processing device connected to a wireless modem. A base station (e.g., access point) may refer to a device in an access network that communicates over the air-interface, through one or more sectors, with wireless terminals. The base station also coordinates management of attributes for the air interface.

The terms used in the disclosure are used merely to describe particular embodiments, and may not be intended to limit the scope of other embodiments. All terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

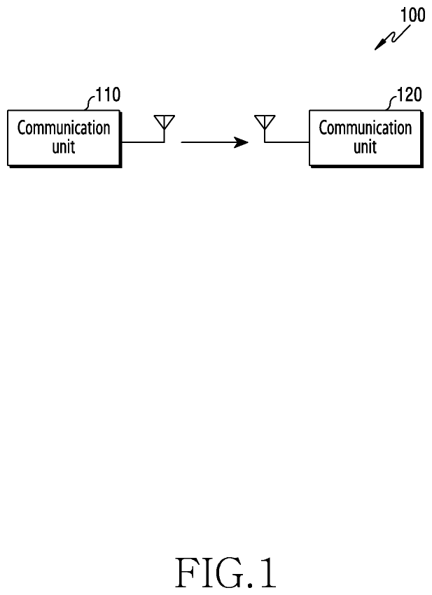

FIG. 1 illustrates a wireless communication system according to an embodiment of the disclosure.

Referring to FIG. 1, as a part of nodes using radio channels in a wireless communication system, a transmission device 110 and a reception device 120 is illustrated. Although FIG. 1 illustrates one transmission device 110 and one reception device 120, the wireless communication system may include multiple transmission devices and multiple reception devices. Also, although the transmission device 110 and the reception device 120 are described as separate entities in the disclosure, the functions of the transmission device 110 and the reception device 120 are interchangeable. For example, in a cellular communication system, the transmission device 110 may be a terminal and the reception device 120 may be a base station in an uplink, and transmission device 110 may be a base station and the reception device 120 may be a terminal in a downlink. According to various embodiments of the disclosure, the base station may be referred to as an “access point (AP)”, an “eNodeB (eNB)”, a “5th generation node (5G node)”, a “wireless point”, a “transmission/reception point (TRP)”, or other terms having technical meanings equivalent thereto. Also, the terminal may be referred to as a “user equipment (UE)”, a “mobile station”, a “subscriber station”, a “remote terminal’, a “wireless terminal”, a “user device”, or other terms having technical meanings equivalent thereto.

The transmission device 110 may transmit signals to the reception device 120. For example, the transmission device 110 may transmit/receive control information and/or data to/from the reception device 120. The reception device 120 may receive signals from the transmission device 100 and perform processing for recovering the signals. The transmission device 110 and the reception device 120 may communicate with each other via various bands of radio channels, based on prearranged radio specifications. For example, the transmission device 110 and the reception device 120 may transmit/receive radio signals in a mmWave band (e.g., 28 GHz, 30 GHz, 38 GHz, or 60 GHz). In this case, to improve channel gain, the transmission device 110 and the reception device 120 may perform beamforming. The beamforming may include transmission beamforming and reception beamforming. That is, the transmission device 110 and the reception device 120 may give directivity to a transmission signal or a reception signal. To this end, transmission device 110 and the reception device 120 may select at least one serving beam through a beam search procedure.

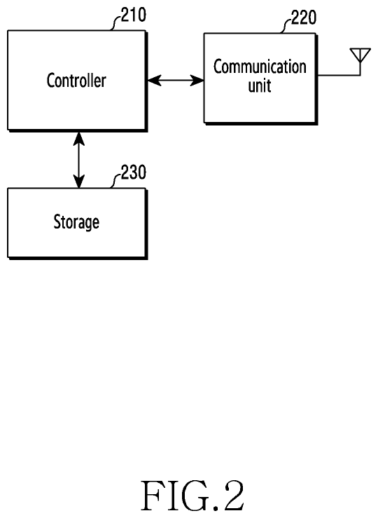

FIG. 2 illustrates a transmission device in a wireless communication system according to an embodiment of the disclosure. The structure illustrated in FIG. 2 may be understood as a structure of the transmission device 110. As used herein, such terms as “ . . . unit“and” . . . er” refer to a unit configured to process at least one function or operation, and may be implemented as hardware, software, or a combination of hardware and software.

Referring to FIG. 2, the transmission device may include a controller 210, a communication unit 220, and a storage 230.

The controller 210 may control the overall operation of the transmission device. For example, the controller 210 may transmit and receive signals through the communication unit 220. In addition, the controller 210 records data in the storage 230 and reads the data from the storage 230. Furthermore, the controller 210 may perform functions of protocol stacks required by communication specifications. To this end, the controller 210 may include at least one processor or microprocessor, or may be a part of a processor. In addition, a part of the communication unit 220 and the controller 210 may be referred to as a communication processor (CP).

According to various embodiments of the disclosure, the controller 210 may generate modulated symbols, based on a modulation scheme, apply modified Fourier transform to the modulated symbols to generate transformed data, generate a transmission signal, based on the transformed data, and control the communication unit 220 to transmit the transmission signal. For example, the controller 210 may control the transmission device to perform operations according to various embodiments as described below.

The communication unit 220 performs functions for transmitting/receiving signals through radio channels. For example, communication unit 220 may perform functions for conversion between baseband signals and bitstrings according to the system's physical layer specifications. For example, during data transmission, the communication unit 220 may generate complex symbols by encoding and modulating a transmission bitstring. In addition, during data reception, the communication unit 220 may reconstruct a reception bitstring by demodulating and decoding a baseband signal. In addition, the communication unit 220 may up-convert a baseband signal into an RF band signal and then transmit the converted RF band signal through an antenna, and down-convert an RF band signal received through an antenna into a baseband signal. For example, the communication unit 220 may include a transmission filter, a reception filter, an amplifier, a mixer, an oscillator, a DAC, an ADC, and the like.

In addition, the communication unit 220 may include multiple transmission/reception paths. Furthermore, the communication unit 220 may include at least one antenna array including multiple antenna elements. In terms of hardware, the communication unit 220 may include a digital circuit and an analog circuit (e.g., a radio frequency integrated circuit (RFIC)). The digital circuit and the analog circuit may be implemented as a single package. In addition, the communication unit 220 may include multiple RF chains. Furthermore, the communication unit 220 may perform beamforming.

The communication unit 220 may transmit and receive signals as described above. Accordingly, all or part of the communication unit 220 may be referred to as a “transmitter”, a “receiver”, or a “transceiver”. In addition, as used in the following description, the meaning of “transmission and reception performed through a radio channel” includes the meaning that the above-described processing is performed by the communication unit 220.

The storage 230 may store basic programs, application programs, and data, such as configuration information, for operation of the main base station. The storage 230 may be configured by volatile memory, nonvolatile memory, or a combination of volatile memory and nonvolatile memory. In addition, the storage 230 may provide the stored data at the request of the controller 210.

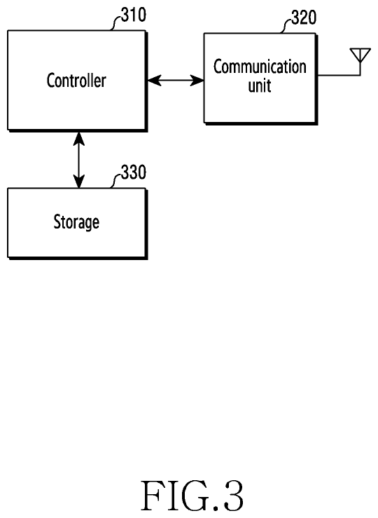

FIG. 3 illustrates a reception device in a wireless communication system according to an embodiment of the disclosure. The structure illustrated in FIG. 3 may be understood as a structure of the reception device 120. As used herein, such terms as “ . . . unit“and” . . . er” refer to a unit configured to process at least one function or operation, and may be implemented as hardware, software, or a combination of hardware and software.

Referring to FIG. 3, the reception device may include a controller 310, a communication unit 320, and a storage 330.

The controller 310 may control the overall operation of the reception device. For example, the controller 310 may transmit and receive signals through the communication unit 320. In addition, the controller 310 records data in the storage 330 and reads the data from the storage 330. In addition, the controller 310 may perform functions of protocol stacks required by communication specifications. To this end, the controller 310 may include at least one processor or microprocessor, or may be a part of a processor. In addition, apart of the communication unit 320 and the controller 310 may be referred to as a communication processor (CP).

According to various embodiments of the disclosure, the controller 310 may generate modulated symbols, based on a modulation scheme, apply modified Fourier transform to the modulated symbols to generate transformed data, generate a transmission signal, based on the transformed data, and control the communication unit 320 to transmit the transmission signal. For example, the controller 310 may control the reception device to perform operations according to various embodiments as described below.

The communication unit 320 may perform functions for transmitting/receiving signals through radio channels. For example, communication unit 320 may perform functions for conversion between baseband signals and bitstrings according to the system's physical layer specifications. For example, during data transmission, the communication unit 320 may generate complex symbols by encoding and modulating a transmission bitstring. In addition, during data reception, the communication unit 320 may reconstruct a reception bitstring by demodulating and decoding a baseband signal. In addition, the communication unit 320 may up-convert a baseband signal into an RF band signal and then transmit the converted RF band signal through an antenna, and down-convert an RF band signal received through an antenna into a baseband signal. For example, the communication unit 320 may include a transmission filter, a reception filter, an amplifier, a mixer, an oscillator, a DAC, and an ADC.

In addition, the communication unit 320 may include multiple transmission/reception paths. Furthermore, the communication unit 320 may include at least one antenna array including multiple antenna elements. In terms of hardware, the communication unit 320 may include a digital circuit and an analog circuit (e.g., a radio frequency integrated circuit (RFIC)). The digital circuit and the analog circuit may be implemented as a single package. In addition, the communication unit 320 may include multiple RF chains. Furthermore, the communication unit 320 may perform beamforming.

The communication unit 320 may transmit and receive signals as described above. Accordingly, all or part of the communication unit 320 may be referred to as a “transmitter”, a “receiver”, or a “transceiver”. In addition, as used in the following description, the meaning of “transmission and reception performed through a radio channel” includes the meaning that the above-described processing is performed by the communication unit 320.

The storage 330 may store basic programs, application programs, and data, such as configuration information, for operation of the main base station. The storage 330 may be configured by volatile memory, nonvolatile memory, or a combination of volatile memory and nonvolatile memory. In addition, the storage 330 may provide the stored data at the request of the controller 310.

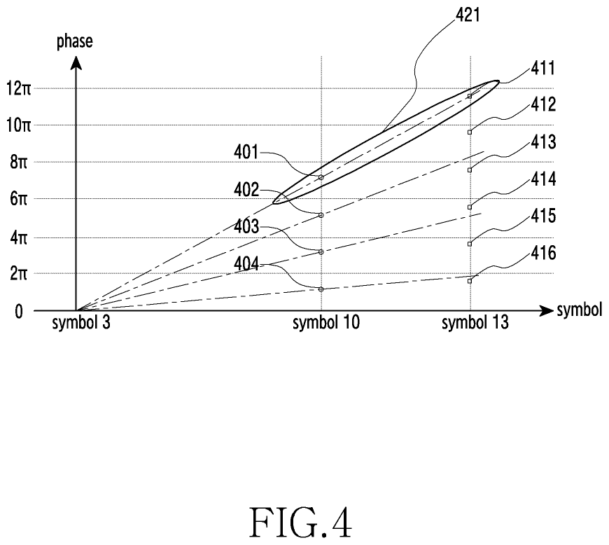

FIG. 4 is a view illustrating estimation of a frequency offset by a transmission device in a wireless communication system according to an embodiment of the disclosure.

According to an embodiment, a frequency offset may be estimated for a reference signal (RS) symbol. According to an embodiment, a symbol may be an orthogonal frequency division multiplexing (OFDM) symbol. In addition, according to an embodiment, the number of OFDM symbols for each symbol may be 14. In addition, according to an embodiment, the mh RS symbol may be referred within the OFDM symbol for each slot, and m may have a value among 0 to 13.

In addition, according to an embodiment of the disclosure, a time interval between RS symbols may be indicated by the number of samples. In addition, the time interval between RS symbols may be indicated by the term “distance between RS symbols.”

A transmission device 110 may calculate a frequency offset for each of a combination of RS symbols. The frequency offset may be calculated through discrete Fourier transform (DFT), and specifically, a DFT process is described by Equations 1 to 4.

$$X ( k ) {\underbrace{↔}}_{DFT pair} x ( n ) \qquad Equation 1$$

In Equation 1, n may indicate a time index, and k may indicate a frequency index.

$$( k ) = {\sum }_{n = 0}^{N - 1} x ( n ) {e}^{- j \frac{2 π k n}{N}} \qquad Equation 2$$

In Equation 2, n may indicate a time index, k may indicate a frequency index, and N may indicate the size of the fast Fourier transform (FFT).

$$X ( k - {k}_{0} ) = {\sum }_{n = 0}^{N - 1} x ( n ) {e}^{- j \frac{2 π ( k - {k}_{0} ) n}{N}} = {\sum }_{n = 0}^{N - 1} ( x ( n ) {e}^{j \frac{2 π {k}_{0} n}{N}} ) {e}^{- j \frac{2 π k n}{N}} \qquad Equation 3$$

In Equation 3, n may indicate a time index, k may indicate a frequency index, and N may indicate the size of the FFT.

$$X ( k - {k}_{0} ) {\underbrace{↔}}_{DFT pair} x ( n ) {e}^{j \frac{2 π {k}_{0} n}{N}} \qquad Equation 4$$

In Equation 4, n may indicate a time index, k may indicate a frequency index, and N may indicate the size of the FFT.

According to an embodiment, ƒ₀ corresponding to a frequency offset can be estimated from a value of phase difference θ at a predetermined interval between RS symbols, based on the characteristic of Equations 1 to 4 and Equations 5 to 7 below.

$$θ = \frac{2 π {k}_{0} {D}_{RS}}{N} \qquad Equation 5$$

In Equation 5, N may indicate the size of the FFT, 0 may indicate a phase difference used for frequency offset estimation, and D_{RS} may indicate the number of symbols between RS symbols used for frequency offset estimation. In addition, D_{RS} may indicate a time interval between RS symbols used for frequency offset estimation, and may indicate the distance between RS symbols.

$${k}_{0} = \frac{θ N}{2 π {D}_{RS}} \qquad Equation 6$$

In Equation 6, N may indicate the size of the FFT, θ may indicate a phase difference used for frequency offset estimation, and D_{RS} may indicate the number of samples between RS symbols used for frequency offset estimation.

$${f}_{0} = {k}_{0} Δ f = \frac{θ N}{2 π {D}_{RS}} Δ f = \frac{θ}{2 π {D}_{RS} {T}_{s}} \qquad Equation 7$$

In Equation 7, N may indicate the size of the FFT, θ may indicate a phase difference used for frequency offset estimation, D_{RS} may indicate the number of samples between RS symbols used for frequency offset estimation, Δƒ may indicate a subcarrier spacing (SCS), Tₛ may indicate

$$\frac{1}{N \cdot Δ f} ,$$

and ƒ₀ may indicate a frequency offset.

In Equation 7, when phase difference θ used for frequency offset estimation is a multiple of 2π, the same frequency value may be obtained according to Equation 4. Accordingly, a case where there is no frequency offset cannot be distinguished only by a phase difference even though there is a time interval between RS symbols may occur. The case where there is no frequency offset cannot be distinguished only by a phase difference even though there is a time interval between RS symbols may be referred to as ambiguity. Accordingly, a frequency offset range can be derived from Equation 8 below.

$$0 \leq {f}_{0} < \frac{1}{{D}_{RS} {T}_{s}} \qquad Equation 8$$

In Equation 8, D_{RS} may indicate the number of symbols between RS symbols used for frequency offset estimation, Tₛ may indicate

$$\frac{1}{N \cdot Δ f} ,$$

N may indicate the size of the FFT, Δƒ may indicate a subcarrier spacing (SCS), and ƒ₀ may indicate a frequency offset. According to an embodiment of the disclosure, a time interval between RS symbols may be indicated by the number of samples. In addition, the time interval between RS symbols may be indicated by the term “distance between RS symbols.”

Based on Equation 8, a maximum value of frequency offset ƒ₀ may be

$$\frac{1}{{D}_{R S} {T}_{s}} .$$

According to an embodiment, the size of the maximum frequency offset may be determined by the reciprocal of D_{RS} corresponding to the number of samples between RS symbols used for frequency offset estimation. In addition, the size of the maximum frequency offset may be determined according to the reciprocal of the time interval between RS symbols or the reciprocal of the distance between RS symbols.

According to an embodiment of the disclosure, the time interval between RS symbols may be indicated by the number of samples. In addition, the time interval between RS symbols may be indicated by the term “distance between RS symbols.”

Accordingly, based on Equation 8, when two RS symbols are used, the farther the distance between two RS symbols, the larger the number of samples, or the greater the time interval, the smaller the size of the maximum frequency offset may be.

According to an embodiment of the disclosure, by adjusting the interval between RS symbols, the range of the frequency offset which can be estimated by three symbols can be extended compared to a case of arrangement at equal intervals even though only two symbols are used or three or more symbols used.

According to an embodiment, the size of the maximum frequency offset can be increased using three RS symbols. Specifically, for three RS symbols, the size of the maximum frequency offset may be increased using the greatest common divisor of the distance between two RS symbols.

According to an embodiment, the ambiguity in the frequency offset may occur when phase difference θ used for frequency offset estimation is a multiple of 2π. Referring to FIG. 4, according to an embodiment, a phase difference between the third symbol and the 10^{th} symbol may be determined to be one of point 401, point 402, point 403, and point 404. The phase in each of the point 401, point 402, point 403, and point 404 differs by the a multiple of 2π, but due to the ambiguity in the frequency offset, a frequency offset estimated between the third symbol and the 10^{th} symbol at each point may be identical.

According to an embodiment, a phase difference between the 10^{th} RS symbol and the 13^{th} RS symbol may be determined to be one of point 411, point 412, point 413, and point 414. The phase in each of the point 411, point 412, point 413, and point 414 differs by a multiple of 2π, but due to the ambiguity in the frequency offset, a frequency offset estimated between the 10^{th} symbol and the 13^{th} symbol at each point may be identical.

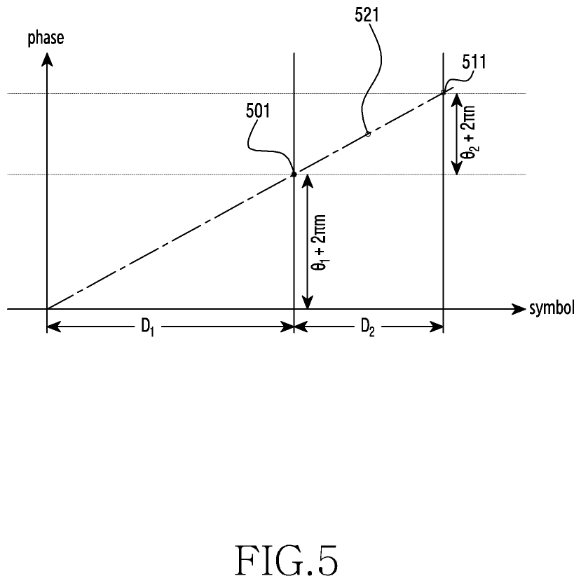

In this case, the frequency offset has linearity, the frequency offset can be estimated based on point 401 and point 411 connected by line 421 among multiple points. This is described in more detail through FIG. 5.

FIG. 5 is another view illustrating estimation of a frequency offset by a transmission device in a wireless communication system according to an embodiment of the disclosure.

Referring to FIG. 5, based on the linearity of a frequency offset, the frequency offset can be estimated based on point 501 and point 511 connected by line 521. Accordingly, a phase difference to be used for estimation of the frequency offset may be determined using the linearity of the frequency offset. Equation 9 below may hold based on the determined phase difference.

$${f}_{0} = \frac{{θ}_{1} + 2 π m}{2 π {D}_{1} {T}_{s}} = \frac{{θ}_{1} + {θ}_{2} + 2 π ( m + n )}{2 π ( {D}_{1} + {D}_{2} ) {T}_{s}} 0 \leq {θ}_{1} , {θ}_{2} < 2 π \qquad Equation 9$$

m and n are natural numbers.

In Equation 9, θ₁+2 πm may indicate a phase difference between a first RS symbol and a second RS symbol, θ₂+2πn may indicate a phase difference between the second RS symbol and a third RS symbol, D₁ may indicate the number of symbols between the first RS symbol and the second RS symbol, D₂ may indicate the number of samples between the second RS symbol and the third RS symbol, Tₛ may indicate

$$\frac{1}{N \cdot Δ f} ,$$

N may indicate the size of the FFT, Δƒ may indicate an SCS, and ƒ₀ may indicate a frequency offset. According to an embodiment of the disclosure, the time interval between RS symbols may be indicated by the number of samples. In addition, the time interval between RS symbols may be indicated by the term “distance between RS symbols.”
Equation 9 can be rearranged into Equation 11 by using Equation 10.

$$\frac{a}{b} = \frac{c}{d} = \frac{a + c}{b + d} \qquad Equation 10$$

$$\frac{{θ}_{1} + 2 π m}{2 π {D}_{1} {T}_{s}} = \frac{{θ}_{2} + 2 π n}{2 π {D}_{2} {T}_{s}} 0 \leq {θ}_{1} , {θ}_{2} < 2 π \qquad Equation 11$$

m and n are natural numbers.

In Equation 11, θ₁+2 πm may indicate a phase difference between a first RS symbol and a second RS symbol, θ₂+2πn may indicate a phase difference between the second RS symbol and a third RS symbol, D₁ may indicate the number of symbols between the first RS symbol and the second RS symbol, D₂ may indicate the number of samples between the second RS symbol and the third RS symbol, Tₛ may indicate

$$\frac{1}{N \cdot Δ f} ,$$

N may indicate the size of the FFT, and Δƒ may indicate an SCS.

Accordingly, minimum values of m and n may be determined through Equation 12 so that a maximum frequency offset can be estimated without ambiguity.

$$\frac{2 π m}{2 π {D}_{1} {T}_{s}} = \frac{2 π n}{2 π {D}_{2} {T}_{s}} \qquad Equation 12$$

m and n are natural numbers.

In Equation 12, D₁ may indicate the number of symbols between the first RS symbol and the second RS symbol, D₂ may indicate the number of samples between the second RS symbol and the third RS symbol, Tₛ may indicate

$$\frac{1}{N \cdot Δ f} ,$$

N may indicate the size of the FFT, and Δƒ may indicate an SCS. According to an embodiment of the disclosure, the time interval between RS symbols may be indicated by the number of samples. In addition, the time interval between RS symbols may be indicated by the term “distance between RS symbols.”

Equation 12 can be rearranged into Equation 13.

$$\frac{m}{{D}_{1}} = \frac{n}{{D}_{2}} \qquad Equation 13$$

m and n are natural numbers.

In Equation 13, D₁ may indicate the number of symbols between the first RS symbol and the second RS symbol, and D₂ may indicate the number of samples between the second RS symbol and the third RS symbol.

The greatest common divisor (GCD) of D₁ and D₂ may be indicated by g, and this may be represented by Equation 14.

$$g = G C D ( {D}_{1} , {D}_{2} ) {D}_{1} = {gD}_{1}^{′} {D}_{2} = {gD}_{2}^{′} \qquad Equation 14$$

In Equation 14, D₁ may indicate the number of symbols between the first RS symbol and the second RS symbol, D₂ may indicate the number of samples between the second RS symbol and the third RS symbol, and g may indicate the greatest common divisor D₁ and D₂. Based on Equation 14, Equation 13 can be rearranged into Equation 15.

$$\frac{m}{{D}_{1}} = \frac{n}{{D}_{2}} ↔ \frac{m}{{gD}_{1}^{′}} = \frac{n}{{gD}_{2}^{′}} ↔ \frac{m}{{D}_{1}^{′}} = \frac{n}{{D}_{2}^{′}} \qquad Equation 15$$

m and n are natural numbers.

In Equation 15, D₁ may indicate the number of symbols between the first RS symbol and the second RS symbol, D₂ may indicate the number of samples between the second RS symbol and the third RS symbol, and g may indicate the greatest common divisor D₁ and D₂. The minimum values of m and n satisfying Equation 15 may be defined in Equation 16 below.

D₁ and D₂ are coprime, and thus Equation 16 can be satisfied as below.

$$m = {D}_{1}^{′} n = {D}_{2}^{′} \qquad Equation 16$$

m and n are natural numbers.

In Equation 16, D′₁ may indicate a value obtained by dividing D₁ by g, D′₂ may indicate a value obtained by dividing D₂ by g, D₁ may indicate the number of symbols between the first RS symbol and the second RS symbol, D₂ may indicate the number of samples between the second RS symbol and the third RS symbol, and g may indicate the greatest common divisor D₁ and D₂.

By applying Equation 16 to Equation 12, the frequency offset range can be derived as Equation 17.

$$0 \leq {f}_{o} < \frac{1}{g {T}_{s}} \qquad Equation 17$$

In Equation 17, g may indicate the greatest common divisor D₁ and D₂, D₁ may indicate the number of symbols between the first RS symbol and the second RS symbol, D₂ may indicate the number of samples between the second RS symbol and the third RS symbol, Tₛ may indicate

$$\frac{1}{N \cdot Δ f} ,$$

N may indicate the size of the FFT, Δƒ may indicate an SCS, and ƒ₀ may indicate a frequency offset. According to an embodiment of the disclosure, the time interval between RS symbols may be indicated by the number of samples. In addition, the time interval between RS symbols may be indicated by the term “distance between RS symbols.”

The maximum frequency offset of Equation 8 is determined by the time interval between RS symbols, but the maximum frequency offset of Equation 17 is determined by the greatest common divisor of the first time interval between RS symbols and a second time interval between RS symbols, and thus a wider range of frequency offsets can be estimated, compared to simply estimating a frequency offset between two RS symbols.

In addition, the maximum frequency offset of Equation 17 may have a larger offset than Equation 18 corresponding to a frequency offset range which can be obtained by selecting two symbols among three symbols.

$$0 \leq {f}_{o} < \frac{1}{min ( {D}_{1} , {D}_{2} ) {T}_{s}} \qquad Equation 18$$

In Equation 18, D₁ may indicate the number of symbols between the first RS symbol and the second RS symbol, D₂ may indicate the number of samples between the second RS symbol and the third RS symbol, Tₛ may indicate

$$\frac{1}{N \cdot Δ f} ,$$

N may indicate the size of the FFT, Δƒ may indicate an SCS, and ƒ₀ may indicate a frequency offset. g is smaller than or equal to min(D₁, D₂), and thus the range of frequency offset ƒ₀ which can be obtained using three symbols may be greater than the range of frequency offset ƒ₀ which can be obtained using two symbols only.

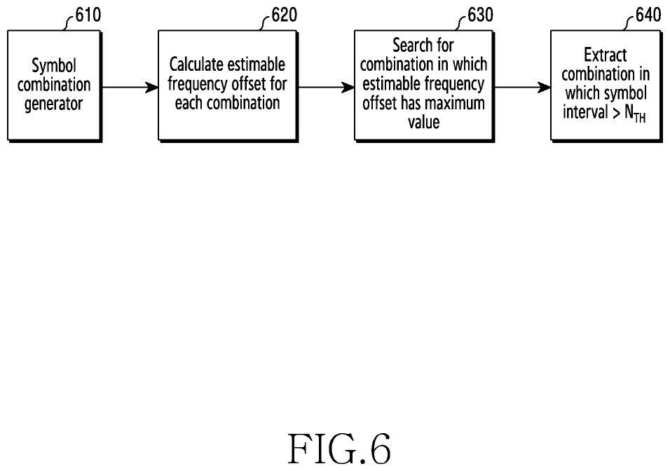

In Equation 17, the range of the frequency offset can be obtained using the greatest common divisor of D₁ and D₂, and a process of extracting a necessary symbol combination by obtaining a maximum value of the frequency offset is described in more detail in FIG. 6.

FIG. 6 is a flowchart illustrating extraction of a symbol combination for estimating a frequency offset by a transmission device in a wireless communication system according to an embodiment of the disclosure. The flowchart may be implemented by hardware, software, or a combination of hardware and software. In addition, the symbol combination may be referred to as a symbol set.

Referring to FIG. 6, in operation 610, a transmission device 110 may extract a combination of RS symbols through a symbol combination generator. According to an embodiment, a symbol may be an OFDM symbol. In addition, according to an embodiment, the number of OFDM symbols for each symbol may be 14. In addition, according to an embodiment, for the m^{th} symbol within the OFDM symbol for each slot, m may have a value among 0 to 13.

According to an embodiment of the disclosure, the transmission device 110 may generate RS symbol combinations including three RS symbols through a symbol combination generator. According to an embodiment, the number of OFDM symbols for each slot may be 14. According to an embodiment of the disclosure, a total number of combinations of RS symbols may be ₁₄C₃, i.e., 364.

In operation 620, the transmission device 110 may calculate a frequency offset for each of the combinations of RS symbols. The frequency offset may be calculated through discrete Fourier transform (DFT), and specifically, may be calculated through Equations 1 to 18.

According to an embodiment of the disclosure, to describe a process of obtaining a maximum offset frequency, a value of SCS and a value of N_{FFT} may be assumed. For example, the value of SCS may be assumed to be 30 kilohertz (kHz), and the value of N_{FFT} may be assumed to be 4096. One symbol may include a sum of N_{CP} and N_{FFT}. The size of FFT may indicate the number of samples when FFT conversion is performed for a symbol in the time domain. According to an embodiment, N_{CP} may be assumed to be 352 in the 0^{th} symbol, and may be assumed to be 288 in a symbol remaining after excluding the 0^{th} symbol. According to an embodiment, N_{CP} may be assumed to be 352 in the 0^{th} symbol, and may be assumed to be 288 in a symbol remaining after excluding the 0^{th} symbol. However, this is for convenience of description, and it does not mean that the scope of the disclosure is limited to the assume value.

According to an embodiment, values of samples of symbols may be defined as in Table 1 below.

TABLE 1

| Sym0 | Sym1 | Sym2 | Sym3 | Sym4 | Sym5 | Sym6 | Sym7 | Sym8 | Sym9 | Sym10 | Sym11 | Sym12 | Sym13 |
|---|---|---|---|---|---|---|---|---|---|---|---|---|---|
| 352 | 4736 | 9120 | 13504 | 17888 | 22272 | 26656 | 31040 | 35424 | 39808 | 44192 | 48576 | 52960 | 57344 |

According to values upon Table 1, a maximum frequency offset may be calculated as follows.

First, an RS interval (D₁, D₂) may be obtained through sample interval unit Tₛ. In this case, (D₁, D₂)=(30688, 13152).

Second, the greatest common divisor of (D₁, D₂) may be obtained. The greatest common divisor of (D₁, D₂) may be 4384.

Third, minimum values m and n may be obtained using the greatest common divisor. Here, m=D₁/GCD and n=D₂/GCD. m=30688/4384=7, and n=13152/4384=3.

Fourth, a maximum frequency offset may be obtained. The maximum frequency offset may be obtained as m/(D₁*Tₛ)=n/(D₂*Tₛ) or 1/(GCD*Tₛ). The maximum frequency offset may be 7/0.24974 ms=3/0.107031 ms=1/(4384*8.138 ns) =28.03 kHz.

When it is applied to all combinations of selecting the positions of three RS symbols from among 14 symbols, a total number of combinations of RS symbols may be ₁₄C₃, i.e., 364. According to an embodiment of the disclosure, the maximum frequency offset for each of the combinations of RS symbols may be calculated below Table 2.

TABLE 2

| 1st | 2nd | 3rd | (2-1) | (3-2) | | | | Max FO |
|---|---|---|---|---|---|---|---|---|
| sym | sym | sym | dist | dist | GCD | k | m | (KHz) |
| 0 | 1 | 2 | 4384 | 4384 | 4384 | 1 | 1 | 28.03 |
| 0 | 1 | 3 | 4384 | 8768 | 4384 | 1 | 2 | 28.03 |
| 0 | 1 | 4 | 4384 | 13152 | 4384 | 1 | 3 | 28.03 |
| 0 | 1 | 5 | 4384 | 17536 | 4384 | 1 | 4 | 28.03 |
| 0 | 1 | 6 | 4384 | 21920 | 4384 | 1 | 5 | 28.03 |
| 0 | 1 | 7 | 4384 | 26304 | 4384 | 1 | 6 | 28.03 |
| 0 | 1 | 8 | 4384 | 30688 | 4384 | 1 | 7 | 28.03 |
| 0 | 1 | 9 | 4384 | 35072 | 4384 | 1 | 8 | 28.03 |
| 0 | 1 | 10 | 4384 | 39456 | 4384 | 1 | 9 | 28.03 |
| 0 | 1 | 11 | 4384 | 43840 | 4384 | 1 | 10 | 28.03 |
| 0 | 1 | 12 | 4384 | 48224 | 4384 | 1 | 11 | 28.03 |
| 0 | 1 | 13 | 4384 | 52608 | 4384 | 1 | 12 | 28.03 |
| 0 | 2 | 3 | 8768 | 4384 | 4384 | 2 | 1 | 28.03 |
| 0 | 2 | 4 | 8768 | 8768 | 8768 | 1 | 1 | 14.01 |
| 0 | 2 | 5 | 8768 | 13152 | 4384 | 2 | 3 | 28.03 |
| 0 | 2 | 6 | 8768 | 17536 | 8768 | 1 | 2 | 14.01 |
| 0 | 2 | 7 | 8768 | 21920 | 4384 | 2 | 5 | 28.03 |
| 0 | 2 | 8 | 8768 | 26304 | 8768 | 1 | 3 | 14.01 |
| 0 | 2 | 9 | 8768 | 30688 | 4384 | 2 | 7 | 28.03 |
| 0 | 2 | 10 | 8768 | 35072 | 8768 | 1 | 4 | 14.01 |
| 0 | 2 | 11 | 8768 | 39456 | 4384 | 2 | 9 | 28.03 |
| 0 | 2 | 12 | 8768 | 43840 | 8768 | 1 | 5 | 14.01 |
| 0 | 2 | 13 | 8768 | 48224 | 4384 | 2 | 11 | 28.03 |
| 0 | 3 | 4 | 13152 | 4384 | 4384 | 3 | 1 | 28.03 |
| 0 | 3 | 5 | 13152 | 8768 | 4384 | 3 | 2 | 28.03 |
| 0 | 3 | 6 | 13152 | 13152 | 13152 | 1 | 1 | 9.34 |
| 0 | 3 | 7 | 13152 | 17536 | 4384 | 3 | 4 | 28.03 |
| 0 | 3 | 8 | 13152 | 21920 | 4384 | 3 | 5 | 28.03 |
| 0 | 3 | 9 | 13152 | 26304 | 13152 | 1 | 2 | 9.34 |
| 0 | 3 | 10 | 13152 | 30688 | 4384 | 3 | 7 | 28.03 |
| 0 | 3 | 11 | 13152 | 35072 | 4384 | 3 | 8 | 28.03 |
| 0 | 3 | 12 | 13152 | 39456 | 13152 | 1 | 3 | 9.34 |
| 0 | 3 | 13 | 13152 | 43840 | 4384 | 3 | 10 | 28.03 |
| 0 | 4 | 5 | 17536 | 4384 | 4384 | 4 | 1 | 28.03 |
| 0 | 4 | 6 | 17536 | 8768 | 8768 | 2 | 1 | 14.01 |
| 0 | 4 | 7 | 17536 | 13152 | 4384 | 4 | 3 | 28.03 |
| 0 | 4 | 8 | 17536 | 17536 | 17536 | 1 | 1 | 7.01 |
| 0 | 4 | 9 | 17536 | 21920 | 4384 | 4 | 5 | 28.03 |
| 0 | 4 | 10 | 17536 | 26304 | 8768 | 2 | 3 | 14.01 |
| 0 | 4 | 11 | 17536 | 30688 | 4384 | 4 | 7 | 28.03 |
| 0 | 4 | 12 | 17536 | 35072 | 17536 | 1 | 2 | 7.01 |
| 0 | 4 | 13 | 17536 | 39456 | 4384 | 4 | 9 | 28.03 |
| 0 | 5 | 6 | 21920 | 4384 | 4384 | 5 | 1 | 28.03 |
| 0 | 5 | 7 | 21920 | 8768 | 4384 | 5 | 2 | 28.03 |
| 0 | 5 | 8 | 21920 | 13152 | 4384 | 5 | 3 | 28.03 |
| 0 | 5 | 9 | 21920 | 17536 | 4384 | 5 | 4 | 28.03 |
| 0 | 5 | 10 | 21920 | 21920 | 21920 | 1 | 1 | 5.61 |
| 0 | 5 | 11 | 21920 | 26304 | 4384 | 5 | 6 | 28.03 |
| 0 | 5 | 12 | 21920 | 30688 | 4384 | 5 | 7 | 28.03 |
| 0 | 5 | 13 | 21920 | 35072 | 4384 | 5 | 8 | 28.03 |
| 0 | 6 | 7 | 26304 | 4384 | 4384 | 6 | 1 | 28.03 |
| 0 | 6 | 8 | 26304 | 8768 | 8768 | 3 | 1 | 14.01 |
| 0 | 6 | 9 | 26304 | 13152 | 13152 | 2 | 1 | 9.34 |
| 0 | 6 | 10 | 26304 | 17536 | 8768 | 3 | 2 | 14.01 |
| 0 | 6 | 11 | 26304 | 21920 | 4384 | 6 | 5 | 28.03 |
| 0 | 6 | 12 | 26304 | 26304 | 26304 | 1 | 1 | 4.67 |
| 0 | 6 | 13 | 26304 | 30688 | 4384 | 6 | 7 | 28.03 |
| 0 | 7 | 8 | 30688 | 4384 | 4384 | 7 | 1 | 28.03 |
| 0 | 7 | 9 | 30688 | 8768 | 4384 | 7 | 2 | 28.03 |
| 0 | 7 | 10 | 30688 | 13152 | 4384 | 7 | 3 | 28.03 |
| 0 | 7 | 11 | 30688 | 17536 | 4384 | 7 | 4 | 28.03 |
| 0 | 7 | 12 | 30688 | 21920 | 4384 | 7 | 5 | 28.03 |
| 0 | 7 | 13 | 30688 | 26304 | 4384 | 7 | 6 | 28.03 |
| 0 | 8 | 9 | 35072 | 4384 | 4384 | 8 | 1 | 28.03 |
| 0 | 8 | 10 | 35072 | 8768 | 8768 | 4 | 1 | 14.01 |
| 0 | 8 | 11 | 35072 | 13152 | 4384 | 8 | 3 | 28.03 |
| 0 | 8 | 12 | 35072 | 17536 | 17536 | 2 | 1 | 7.01 |
| 0 | 8 | 13 | 35072 | 21920 | 4384 | 8 | 5 | 28.03 |
| 0 | 9 | 10 | 39456 | 4384 | 4384 | 9 | 1 | 28.03 |
| 0 | 9 | 11 | 39456 | 8768 | 4384 | 9 | 2 | 28.03 |
| 0 | 9 | 12 | 39456 | 13152 | 13152 | 3 | 1 | 9.34 |
| 0 | 9 | 13 | 39456 | 17536 | 4384 | 9 | 4 | 28.03 |
| 0 | 10 | 11 | 43840 | 4384 | 4384 | 10 | 1 | 28.03 |
| 0 | 10 | 12 | 43840 | 8768 | 8768 | 5 | 1 | 14.01 |
| 0 | 10 | 13 | 43840 | 13152 | 4384 | 10 | 3 | 28.03 |
| 0 | 11 | 12 | 48224 | 4384 | 4384 | 11 | 1 | 28.03 |
| 0 | 11 | 13 | 48224 | 8768 | 4384 | 11 | 2 | 28.03 |
| 0 | 12 | 13 | 52608 | 4384 | 4384 | 12 | 1 | 28.03 |
| 1 | 2 | 3 | 4384 | 4384 | 4384 | 1 | 1 | 28.03 |
| 1 | 2 | 4 | 4384 | 8768 | 4384 | 1 | 2 | 28.03 |
| 1 | 2 | 5 | 4384 | 13152 | 4384 | 1 | 3 | 28.03 |
| 1 | 2 | 6 | 4384 | 17536 | 4384 | 1 | 4 | 28.03 |
| 1 | 2 | 7 | 4384 | 21920 | 4384 | 1 | 5 | 28.03 |
| 1 | 2 | 8 | 4384 | 26304 | 4384 | 1 | 6 | 28.03 |
| 1 | 2 | 9 | 4384 | 30688 | 4384 | 1 | 7 | 28.03 |
| 1 | 2 | 10 | 4384 | 35072 | 4384 | 1 | 8 | 28.03 |
| 1 | 2 | 11 | 4384 | 39456 | 4384 | 1 | 9 | 28.03 |
| 1 | 2 | 12 | 4384 | 43840 | 4384 | 1 | 10 | 28.03 |
| 1 | 2 | 13 | 4384 | 48224 | 4384 | 1 | 11 | 28.03 |
| 1 | 3 | 4 | 8768 | 4384 | 4384 | 2 | 1 | 28.03 |
| 1 | 3 | 5 | 8768 | 8768 | 8768 | 1 | 1 | 14.01 |
| 1 | 3 | 6 | 8768 | 13152 | 4384 | 2 | 3 | 28.03 |
| 1 | 3 | 7 | 8768 | 17536 | 8768 | 1 | 2 | 14.01 |
| 1 | 3 | 8 | 8768 | 21920 | 4384 | 2 | 5 | 28.03 |
| 1 | 3 | 9 | 8768 | 26304 | 8768 | 1 | 3 | 14.01 |
| 1 | 3 | 10 | 8768 | 30688 | 4384 | 2 | 7 | 28.03 |
| 1 | 3 | 11 | 8768 | 35072 | 8768 | 1 | 4 | 14.01 |
| 1 | 3 | 12 | 8768 | 39456 | 4384 | 2 | 9 | 28.03 |
| 1 | 3 | 13 | 8768 | 43840 | 8768 | 1 | 5 | 14.01 |
| 1 | 4 | 5 | 13152 | 4384 | 4384 | 3 | 1 | 28.03 |
| 1 | 4 | 6 | 13152 | 8768 | 4384 | 3 | 2 | 28.03 |
| 1 | 4 | 7 | 13152 | 13152 | 13152 | 1 | 1 | 9.34 |
| 1 | 4 | 8 | 13152 | 17536 | 4384 | 3 | 4 | 28.03 |
| 1 | 4 | 9 | 13152 | 21920 | 4384 | 3 | 5 | 28.03 |
| 1 | 4 | 10 | 13152 | 26304 | 13152 | 1 | 2 | 9.34 |
| 1 | 4 | 11 | 13152 | 30688 | 4384 | 3 | 7 | 28.03 |
| 1 | 4 | 12 | 13152 | 35072 | 4384 | 3 | 8 | 28.03 |
| 1 | 4 | 13 | 13152 | 39456 | 13152 | 1 | 3 | 9.34 |
| 1 | 5 | 6 | 17536 | 4384 | 4384 | 4 | 1 | 28.03 |
| 1 | 5 | 7 | 17536 | 8768 | 8768 | 2 | 1 | 14.01 |
| 1 | 5 | 8 | 17536 | 13152 | 4384 | 4 | 3 | 28.03 |
| 1 | 5 | 9 | 17536 | 17536 | 17536 | 1 | 1 | 7.01 |
| 1 | 5 | 10 | 17536 | 21920 | 4384 | 4 | 5 | 28.03 |
| 1 | 5 | 11 | 17536 | 26304 | 8768 | 2 | 3 | 14.01 |
| 1 | 5 | 12 | 17536 | 30688 | 4384 | 4 | 7 | 28.03 |
| 1 | 5 | 13 | 17536 | 35072 | 17536 | 1 | 2 | 7.01 |
| 1 | 6 | 7 | 21920 | 4384 | 4384 | 5 | 1 | 28.03 |
| 1 | 6 | 8 | 21920 | 8768 | 4384 | 5 | 2 | 28.03 |
| 1 | 6 | 9 | 21920 | 13152 | 4384 | 5 | 3 | 28.03 |
| 1 | 6 | 10 | 21920 | 17536 | 4384 | 5 | 4 | 28.03 |
| 1 | 6 | 11 | 21920 | 21920 | 21920 | 1 | 1 | 5.61 |
| 1 | 6 | 12 | 21920 | 26304 | 4384 | 5 | 6 | 28.03 |
| 1 | 6 | 13 | 21920 | 30688 | 4384 | 5 | 7 | 28.03 |
| 1 | 7 | 8 | 26304 | 4384 | 4384 | 6 | 1 | 28.03 |
| 1 | 7 | 9 | 26304 | 8768 | 8768 | 3 | 1 | 14.01 |
| 1 | 7 | 10 | 26304 | 13152 | 13152 | 2 | 1 | 9.34 |
| 1 | 7 | 11 | 26304 | 17536 | 8768 | 3 | 2 | 14.01 |
| 1 | 7 | 12 | 26304 | 21920 | 4384 | 6 | 5 | 28.03 |
| 1 | 7 | 13 | 26304 | 26304 | 26304 | 1 | 1 | 4.67 |
| 1 | 8 | 9 | 30688 | 4384 | 4384 | 7 | 1 | 28.03 |
| 1 | 8 | 10 | 30688 | 8768 | 4384 | 7 | 2 | 28.03 |
| 1 | 8 | 11 | 30688 | 13152 | 4384 | 7 | 3 | 28.03 |
| 1 | 8 | 12 | 30688 | 17536 | 4384 | 7 | 4 | 28.03 |
| 1 | 8 | 13 | 30688 | 21920 | 4384 | 7 | 5 | 28.03 |
| 1 | 9 | 10 | 35072 | 4384 | 4384 | 8 | 1 | 28.03 |
| 1 | 9 | 11 | 35072 | 8768 | 8768 | 4 | 1 | 14.01 |
| 1 | 9 | 12 | 35072 | 13152 | 4384 | 8 | 3 | 28.03 |
| 1 | 9 | 13 | 35072 | 17536 | 17536 | 2 | 1 | 7.01 |
| 1 | 10 | 11 | 39456 | 4384 | 4384 | 9 | 1 | 28.03 |
| 1 | 10 | 12 | 39456 | 8768 | 4384 | 9 | 2 | 28.03 |
| 1 | 10 | 13 | 39456 | 13152 | 13152 | 3 | 1 | 9.34 |
| 1 | 11 | 12 | 43840 | 4384 | 4384 | 10 | 1 | 28.03 |
| 1 | 11 | 13 | 43840 | 8768 | 8768 | 5 | 1 | 14.01 |
| 1 | 12 | 13 | 48224 | 4384 | 4384 | 11 | 1 | 28.03 |
| 2 | 3 | 4 | 4384 | 4384 | 4384 | 1 | 1 | 28.03 |
| 2 | 3 | 5 | 4384 | 8768 | 4384 | 1 | 2 | 28.03 |
| 2 | 3 | 6 | 4384 | 13152 | 4384 | 1 | 3 | 28.03 |
| 2 | 3 | 7 | 4384 | 17536 | 4384 | 1 | 4 | 28.03 |
| 2 | 3 | 8 | 4384 | 21920 | 4384 | 1 | 5 | 28.03 |
| 2 | 3 | 9 | 4384 | 26304 | 4384 | 1 | 6 | 28.03 |
| 2 | 3 | 10 | 4384 | 30688 | 4384 | 1 | 7 | 28.03 |
| 2 | 3 | 11 | 4384 | 35072 | 4384 | 1 | 8 | 28.03 |
| 2 | 3 | 12 | 4384 | 39456 | 4384 | 1 | 9 | 28.03 |
| 2 | 3 | 13 | 4384 | 43840 | 4384 | 1 | 10 | 28.03 |
| 2 | 4 | 5 | 8768 | 4384 | 4384 | 2 | 1 | 28.03 |
| 2 | 4 | 6 | 8768 | 8768 | 8768 | 1 | 1 | 14.01 |
| 2 | 4 | 7 | 8768 | 13152 | 4384 | 2 | 3 | 28.03 |
| 2 | 4 | 8 | 8768 | 17536 | 8768 | 1 | 2 | 14.01 |
| 2 | 4 | 9 | 8768 | 21920 | 4384 | 2 | 5 | 28.03 |
| 2 | 4 | 10 | 8768 | 26304 | 8768 | 1 | 3 | 14.01 |
| 2 | 4 | 11 | 8768 | 30688 | 4384 | 2 | 7 | 28.03 |
| 2 | 4 | 12 | 8768 | 35072 | 8768 | 1 | 4 | 14.01 |
| 2 | 4 | 13 | 8768 | 39456 | 4384 | 2 | 9 | 28.03 |
| 2 | 5 | 6 | 13152 | 4384 | 4384 | 3 | 1 | 28.03 |
| 2 | 5 | 7 | 13152 | 8768 | 4384 | 3 | 2 | 28.03 |
| 2 | 5 | 8 | 13152 | 13152 | 13152 | 1 | 1 | 9.34 |
| 2 | 5 | 9 | 13152 | 17536 | 4384 | 3 | 4 | 28.03 |
| 2 | 5 | 10 | 13152 | 21920 | 4384 | 3 | 5 | 28.03 |
| 2 | 5 | 11 | 13152 | 26304 | 13152 | 1 | 2 | 9.34 |
| 2 | 5 | 12 | 13152 | 30688 | 4384 | 3 | 7 | 28.03 |
| 2 | 5 | 13 | 13152 | 35072 | 4384 | 3 | 8 | 28.03 |
| 2 | 6 | 7 | 17536 | 4384 | 4384 | 4 | 1 | 28.03 |
| 2 | 6 | 8 | 17536 | 8768 | 8768 | 2 | 1 | 14.01 |
| 2 | 6 | 9 | 17536 | 13152 | 4384 | 4 | 3 | 28.03 |
| 2 | 6 | 10 | 17536 | 17536 | 17536 | 1 | 1 | 7.01 |
| 2 | 6 | 11 | 17536 | 21920 | 4384 | 4 | 5 | 28.03 |
| 2 | 6 | 12 | 17536 | 26304 | 8768 | 2 | 3 | 14.01 |
| 2 | 6 | 13 | 17536 | 30688 | 4384 | 4 | 7 | 28.03 |
| 2 | 7 | 8 | 21920 | 4384 | 4384 | 5 | 1 | 28.03 |
| 2 | 7 | 9 | 21920 | 8768 | 4384 | 5 | 2 | 28.03 |
| 2 | 7 | 10 | 21920 | 13152 | 4384 | 5 | 3 | 28.03 |
| 2 | 7 | 11 | 21920 | 17536 | 4384 | 5 | 4 | 28.03 |
| 2 | 7 | 12 | 21920 | 21920 | 21920 | 1 | 1 | 5.61 |
| 2 | 7 | 13 | 21920 | 26304 | 4384 | 5 | 6 | 28.03 |
| 2 | 8 | 9 | 26304 | 4384 | 4384 | 6 | 1 | 28.03 |
| 2 | 8 | 10 | 26304 | 8768 | 8768 | 3 | 1 | 14.01 |
| 2 | 8 | 11 | 26304 | 13152 | 13152 | 2 | 1 | 9.34 |
| 2 | 8 | 12 | 26304 | 17536 | 8768 | 3 | 2 | 14.01 |
| 2 | 8 | 13 | 26304 | 21920 | 4384 | 6 | 5 | 28.03 |
| 2 | 9 | 10 | 30688 | 4384 | 4384 | 7 | 1 | 28.03 |
| 2 | 9 | 11 | 30688 | 8768 | 4384 | 7 | 2 | 28.03 |
| 2 | 9 | 12 | 30688 | 13152 | 4384 | 7 | 3 | 28.03 |
| 2 | 9 | 13 | 30688 | 17536 | 4384 | 7 | 4 | 28.03 |
| 2 | 10 | 11 | 35072 | 4384 | 4384 | 8 | 1 | 28.03 |
| 2 | 10 | 12 | 35072 | 8768 | 8768 | 4 | 1 | 14.01 |
| 2 | 10 | 13 | 35072 | 13152 | 4384 | 8 | 3 | 28.03 |
| 2 | 11 | 12 | 39456 | 4384 | 4384 | 9 | 1 | 28.03 |
| 2 | 11 | 13 | 39456 | 8768 | 4384 | 9 | 2 | 28.03 |
| 2 | 12 | 13 | 43840 | 4384 | 4384 | 10 | 1 | 28.03 |
| 3 | 4 | 5 | 4384 | 4384 | 4384 | 1 | 1 | 28.03 |
| 3 | 4 | 6 | 4384 | 8768 | 4384 | 1 | 2 | 28.03 |
| 3 | 4 | 7 | 4384 | 13152 | 4384 | 1 | 3 | 28.03 |
| 3 | 4 | 8 | 4384 | 17536 | 4384 | 1 | 4 | 28.03 |
| 3 | 4 | 9 | 4384 | 21920 | 4384 | 1 | 5 | 28.03 |
| 3 | 4 | 10 | 4384 | 26304 | 4384 | 1 | 6 | 28.03 |
| 3 | 4 | 11 | 4384 | 30688 | 4384 | 1 | 7 | 28.03 |
| 3 | 4 | 12 | 4384 | 35072 | 4384 | 1 | 8 | 28.03 |
| 3 | 4 | 13 | 4384 | 39456 | 4384 | 1 | 9 | 28.03 |
| 3 | 5 | 6 | 8768 | 4384 | 4384 | 2 | 1 | 28.03 |
| 3 | 5 | 7 | 8768 | 8768 | 8768 | 1 | 1 | 14.01 |
| 3 | 5 | 8 | 8768 | 13152 | 4384 | 2 | 3 | 28.03 |
| 3 | 5 | 9 | 8768 | 17536 | 8768 | 1 | 2 | 14.01 |
| 3 | 5 | 10 | 8768 | 21920 | 4384 | 2 | 5 | 28.03 |
| 3 | 5 | 11 | 8768 | 26304 | 8768 | 1 | 3 | 14.01 |
| 3 | 5 | 12 | 8768 | 30688 | 4384 | 2 | 7 | 28.03 |
| 3 | 5 | 13 | 8768 | 35072 | 8768 | 1 | 4 | 14.01 |
| 3 | 6 | 7 | 13152 | 4384 | 4384 | 3 | 1 | 28.03 |
| 3 | 6 | 8 | 13152 | 8768 | 4384 | 3 | 2 | 28.03 |
| 3 | 6 | 9 | 13152 | 13152 | 13152 | 1 | 1 | 9.34 |
| 3 | 6 | 10 | 13152 | 17536 | 4384 | 3 | 4 | 28.03 |
| 3 | 6 | 11 | 13152 | 21920 | 4384 | 3 | 5 | 28.03 |
| 3 | 6 | 12 | 13152 | 26304 | 13152 | 1 | 2 | 9.34 |
| 3 | 6 | 13 | 13152 | 30688 | 4384 | 3 | 7 | 28.03 |
| 3 | 7 | 8 | 17536 | 4384 | 4384 | 4 | 1 | 28.03 |
| 3 | 7 | 9 | 17536 | 8768 | 8768 | 2 | 1 | 14.01 |
| 3 | 7 | 10 | 17536 | 13152 | 4384 | 4 | 3 | 28.03 |
| 3 | 7 | 11 | 17536 | 17536 | 17536 | 1 | 1 | 7.01 |
| 3 | 7 | 12 | 17536 | 21920 | 4384 | 4 | 5 | 28.03 |
| 3 | 7 | 13 | 17536 | 26304 | 8768 | 2 | 3 | 14.01 |
| 3 | 8 | 9 | 21920 | 4384 | 4384 | 5 | 1 | 28.03 |
| 3 | 8 | 10 | 21920 | 8768 | 4384 | 5 | 2 | 28.03 |
| 3 | 8 | 11 | 21920 | 13152 | 4384 | 5 | 3 | 28.03 |
| 3 | 8 | 12 | 21920 | 17536 | 4384 | 5 | 4 | 28.03 |
| 3 | 8 | 13 | 21920 | 21920 | 21920 | 1 | 1 | 5.61 |
| 3 | 9 | 10 | 26304 | 4384 | 4384 | 6 | 1 | 28.03 |
| 3 | 9 | 11 | 26304 | 8768 | 8768 | 3 | 1 | 14.01 |
| 3 | 9 | 12 | 26304 | 13152 | 13152 | 2 | 1 | 9.34 |
| 3 | 9 | 13 | 26304 | 17536 | 8768 | 3 | 2 | 14.01 |
| 3 | 10 | 11 | 30688 | 4384 | 4384 | 7 | 1 | 28.03 |
| 3 | 10 | 12 | 30688 | 8768 | 4384 | 7 | 2 | 28.03 |
| 3 | 10 | 13 | 30688 | 13152 | 4384 | 7 | 3 | 28.03 |
| 3 | 11 | 12 | 35072 | 4384 | 4384 | 8 | 1 | 28.03 |
| 3 | 11 | 13 | 35072 | 8768 | 8768 | 4 | 1 | 14.01 |
| 3 | 12 | 13 | 39456 | 4384 | 4384 | 9 | 1 | 28.03 |
| 4 | 5 | 6 | 4384 | 4384 | 4384 | 1 | 1 | 28.03 |
| 4 | 5 | 7 | 4384 | 8768 | 4384 | 1 | 2 | 28.03 |
| 4 | 5 | 8 | 4384 | 13152 | 4384 | 1 | 3 | 28.03 |
| 4 | 5 | 9 | 4384 | 17536 | 4384 | 1 | 4 | 28.03 |
| 4 | 5 | 10 | 4384 | 21920 | 4384 | 1 | 5 | 28.03 |
| 4 | 5 | 11 | 4384 | 26304 | 4384 | 1 | 6 | 28.03 |
| 4 | 5 | 12 | 4384 | 30688 | 4384 | 1 | 7 | 28.03 |
| 4 | 5 | 13 | 4384 | 35072 | 4384 | 1 | 8 | 28.03 |
| 4 | 6 | 7 | 8768 | 4384 | 4384 | 2 | 1 | 28.03 |
| 4 | 6 | 8 | 8768 | 8768 | 8768 | 1 | 1 | 14.01 |
| 4 | 6 | 9 | 8768 | 13152 | 4384 | 2 | 3 | 28.03 |
| 4 | 6 | 10 | 8768 | 17536 | 8768 | 1 | 2 | 14.01 |
| 4 | 6 | 11 | 8768 | 21920 | 4384 | 2 | 5 | 28.03 |
| 4 | 6 | 12 | 8768 | 26304 | 8768 | 1 | 3 | 14.01 |
| 4 | 6 | 13 | 8768 | 30688 | 4384 | 2 | 7 | 28.03 |
| 4 | 7 | 8 | 13152 | 4384 | 4384 | 3 | 1 | 28.03 |
| 4 | 7 | 9 | 13152 | 8768 | 4384 | 3 | 2 | 28.03 |
| 4 | 7 | 10 | 13152 | 13152 | 13152 | 1 | 1 | 9.34 |
| 4 | 7 | 11 | 13152 | 17536 | 4384 | 3 | 4 | 28.03 |
| 4 | 7 | 12 | 13152 | 21920 | 4384 | 3 | 5 | 28.03 |
| 4 | 7 | 13 | 13152 | 26304 | 13152 | 1 | 2 | 9.34 |
| 4 | 8 | 9 | 17536 | 4384 | 4384 | 4 | 1 | 28.03 |
| 4 | 8 | 10 | 17536 | 8768 | 8768 | 2 | 1 | 14.01 |
| 4 | 8 | 11 | 17536 | 13152 | 4384 | 4 | 3 | 28.03 |
| 4 | 8 | 12 | 17536 | 17536 | 17536 | 1 | 1 | 7.01 |
| 4 | 8 | 13 | 17536 | 21920 | 4384 | 4 | 5 | 28.03 |
| 4 | 9 | 10 | 21920 | 4384 | 4384 | 5 | 1 | 28.03 |
| 4 | 9 | 11 | 21920 | 8768 | 4384 | 5 | 2 | 28.03 |
| 4 | 9 | 12 | 21920 | 13152 | 4384 | 5 | 3 | 28.03 |
| 4 | 9 | 13 | 21920 | 17536 | 4384 | 5 | 4 | 28.03 |
| 4 | 10 | 11 | 26304 | 4384 | 4384 | 6 | 1 | 28.03 |
| 4 | 10 | 12 | 26304 | 8768 | 8768 | 3 | 1 | 14.01 |
| 4 | 10 | 13 | 26304 | 13152 | 13152 | 2 | 1 | 9.34 |
| 4 | 11 | 12 | 30688 | 4384 | 4384 | 7 | 1 | 28.03 |
| 4 | 11 | 13 | 30688 | 8768 | 4384 | 7 | 2 | 28.03 |
| 4 | 12 | 13 | 35072 | 4384 | 4384 | 8 | 1 | 28.03 |
| 5 | 6 | 7 | 4384 | 4384 | 4384 | 1 | 1 | 28.03 |
| 5 | 6 | 8 | 4384 | 8768 | 4384 | 1 | 2 | 28.03 |
| 5 | 6 | 9 | 4384 | 13152 | 4384 | 1 | 3 | 28.03 |
| 5 | 6 | 10 | 4384 | 17536 | 4384 | 1 | 4 | 28.03 |
| 5 | 6 | 11 | 4384 | 21920 | 4384 | 1 | 5 | 28.03 |
| 5 | 6 | 12 | 4384 | 26304 | 4384 | 1 | 6 | 28.03 |
| 5 | 6 | 13 | 4384 | 30688 | 4384 | 1 | 7 | 28.03 |
| 5 | 7 | 8 | 8768 | 4384 | 4384 | 2 | 1 | 28.03 |
| 5 | 7 | 9 | 8768 | 8768 | 8768 | 1 | 1 | 14.01 |
| 5 | 7 | 10 | 8768 | 13152 | 4384 | 2 | 3 | 28.03 |
| 5 | 7 | 11 | 8768 | 17536 | 8768 | 1 | 2 | 14.01 |
| 5 | 7 | 12 | 8768 | 21920 | 4384 | 2 | 5 | 28.03 |
| 5 | 7 | 13 | 8768 | 26304 | 8768 | 1 | 3 | 14.01 |
| 5 | 8 | 9 | 13152 | 4384 | 4384 | 3 | 1 | 28.03 |
| 5 | 8 | 10 | 13152 | 8768 | 4384 | 3 | 2 | 28.03 |
| 5 | 8 | 11 | 13152 | 13152 | 13152 | 1 | 1 | 9.34 |
| 5 | 8 | 12 | 13152 | 17536 | 4384 | 3 | 4 | 28.03 |
| 5 | 8 | 13 | 13152 | 21920 | 4384 | 3 | 5 | 28.03 |
| 5 | 9 | 10 | 17536 | 4384 | 4384 | 4 | 1 | 28.03 |
| 5 | 9 | 11 | 17536 | 8768 | 8768 | 2 | 1 | 14.01 |
| 5 | 9 | 12 | 17536 | 13152 | 4384 | 4 | 3 | 28.03 |
| 5 | 9 | 13 | 17536 | 17536 | 17536 | 1 | 1 | 7.01 |
| 5 | 10 | 11 | 21920 | 4384 | 4384 | 5 | 1 | 28.03 |
| 5 | 10 | 12 | 21920 | 8768 | 4384 | 5 | 2 | 28.03 |
| 5 | 10 | 13 | 21920 | 13152 | 4384 | 5 | 3 | 28.03 |
| 5 | 11 | 12 | 26304 | 4384 | 4384 | 6 | 1 | 28.03 |
| 5 | 11 | 13 | 26304 | 8768 | 8768 | 3 | 1 | 14.01 |
| 5 | 12 | 13 | 30688 | 4384 | 4384 | 7 | 1 | 28.03 |
| 6 | 7 | 8 | 4384 | 4384 | 4384 | 1 | 1 | 28.03 |
| 6 | 7 | 9 | 4384 | 8768 | 4384 | 1 | 2 | 28.03 |
| 6 | 7 | 10 | 4384 | 13152 | 4384 | 1 | 3 | 28.03 |
| 6 | 7 | 11 | 4384 | 17536 | 4384 | 1 | 4 | 28.03 |
| 6 | 7 | 12 | 4384 | 21920 | 4384 | 1 | 5 | 28.03 |
| 6 | 7 | 13 | 4384 | 26304 | 4384 | 1 | 6 | 28.03 |
| 6 | 8 | 9 | 8768 | 4384 | 4384 | 2 | 1 | 28.03 |
| 6 | 8 | 10 | 8768 | 8768 | 8768 | 1 | 1 | 14.01 |
| 6 | 8 | 11 | 8768 | 13152 | 4384 | 2 | 3 | 28.03 |
| 6 | 8 | 12 | 8768 | 17536 | 8768 | 1 | 2 | 14.01 |
| 6 | 8 | 13 | 8768 | 21920 | 4384 | 2 | 5 | 28.03 |
| 6 | 9 | 10 | 13152 | 4384 | 4384 | 3 | 1 | 28.03 |
| 6 | 9 | 11 | 13152 | 8768 | 4384 | 3 | 2 | 28.03 |
| 6 | 9 | 12 | 13152 | 13152 | 13152 | 1 | 1 | 9.34 |
| 6 | 9 | 13 | 13152 | 17536 | 4384 | 3 | 4 | 28.03 |
| 6 | 10 | 11 | 17536 | 4384 | 4384 | 4 | 1 | 28.03 |
| 6 | 10 | 12 | 17536 | 8768 | 8768 | 2 | 1 | 14.01 |
| 6 | 10 | 13 | 17536 | 13152 | 4384 | 4 | 3 | 28.03 |
| 6 | 11 | 12 | 21920 | 4384 | 4384 | 5 | 1 | 28.03 |
| 6 | 11 | 13 | 21920 | 8768 | 4384 | 5 | 2 | 28.03 |
| 6 | 12 | 13 | 26304 | 4384 | 4384 | 6 | 1 | 28.03 |
| 7 | 8 | 9 | 4384 | 4384 | 4384 | 1 | 1 | 28.03 |
| 7 | 8 | 10 | 4384 | 8768 | 4384 | 1 | 2 | 28.03 |
| 7 | 8 | 11 | 4384 | 13152 | 4384 | 1 | 3 | 28.03 |
| 7 | 8 | 12 | 4384 | 17536 | 4384 | 1 | 4 | 28.03 |
| 7 | 8 | 13 | 4384 | 21920 | 4384 | 1 | 5 | 28.03 |
| 7 | 9 | 10 | 8768 | 4384 | 4384 | 2 | 1 | 28.03 |
| 7 | 9 | 11 | 8768 | 8768 | 8768 | 1 | 1 | 14.01 |
| 7 | 9 | 12 | 8768 | 13152 | 4384 | 2 | 3 | 28.03 |
| 7 | 9 | 13 | 8768 | 17536 | 8768 | 1 | 2 | 14.01 |
| 7 | 10 | 11 | 13152 | 4384 | 4384 | 3 | 1 | 28.03 |
| 7 | 10 | 12 | 13152 | 8768 | 4384 | 3 | 2 | 28.03 |
| 7 | 10 | 13 | 13152 | 13152 | 13152 | 1 | 1 | 9.34 |
| 7 | 11 | 12 | 17536 | 4384 | 4384 | 4 | 1 | 28.03 |
| 7 | 11 | 13 | 17536 | 8768 | 8768 | 2 | 1 | 14.01 |
| 7 | 12 | 13 | 21920 | 4384 | 4384 | 5 | 1 | 28.03 |
| 8 | 9 | 10 | 4384 | 4384 | 4384 | 1 | 1 | 28.03 |
| 8 | 9 | 11 | 4384 | 8768 | 4384 | 1 | 2 | 28.03 |
| 8 | 9 | 12 | 4384 | 13152 | 4384 | 1 | 3 | 28.03 |
| 8 | 9 | 13 | 4384 | 17536 | 4384 | 1 | 4 | 28.03 |
| 8 | 10 | 11 | 8768 | 4384 | 4384 | 2 | 1 | 28.03 |
| 8 | 10 | 12 | 8768 | 8768 | 8768 | 1 | 1 | 14.01 |
| 8 | 10 | 13 | 8768 | 13152 | 4384 | 2 | 3 | 28.03 |
| 8 | 11 | 12 | 13152 | 4384 | 4384 | 3 | 1 | 28.03 |
| 8 | 11 | 13 | 13152 | 8768 | 4384 | 3 | 2 | 28.03 |
| 8 | 12 | 13 | 17536 | 4384 | 4384 | 4 | 1 | 28.03 |
| 9 | 10 | 11 | 4384 | 4384 | 4384 | 1 | 1 | 28.03 |
| 9 | 10 | 12 | 4384 | 8768 | 4384 | 1 | 2 | 28.03 |
| 9 | 10 | 13 | 4384 | 13152 | 4384 | 1 | 3 | 28.03 |
| 9 | 11 | 12 | 8768 | 4384 | 4384 | 2 | 1 | 28.03 |
| 9 | 11 | 13 | 8768 | 8768 | 8768 | 1 | 1 | 14.01 |
| 9 | 12 | 13 | 13152 | 4384 | 4384 | 3 | 1 | 28.03 |
| 10 | 11 | 12 | 4384 | 4384 | 4384 | 1 | 1 | 28.03 |
| 10 | 11 | 13 | 4384 | 8768 | 4384 | 1 | 2 | 28.03 |
| 10 | 12 | 13 | 8768 | 4384 | 4384 | 2 | 1 | 28.03 |
| 11 | 12 | 13 | 4384 | 4384 | 4384 | 1 | 1 | 28.03 |

According to an embodiment of the disclosure, by adjusting the interval between RS symbols, the range of the frequency offset which can be estimated by three symbols can be largely extended compared to a case of arrangement at equal intervals even though only two symbols are used or three or more symbols used. When it is described using Table 2, the range of frequency offsets which can be estimated using three symbols in a case of symbols at equal intervals may be theoretically extended from the lowest 4.67 kHz up to 28.03 kHz through irregular allocation.

In operation 630, a combination of RS symbols having a maximum estimable frequency offset may be found. According to an embodiment of the disclosure, the number of combinations of positions of three RS symbols in which a maximum frequency offset is 28.03 kHz may be 268 in Table 1. In addition, when there are several symbol arrangement combinations achieving the maximum estimable frequency offset, one of the combinations may be selected and used in consideration of other elements such as a symbol position and a minimum symbol interval.

According to an embodiment of the disclosure, the channel estimation performance, or the like can be increased through the arrangement RS symbols, and in order to increase the channel estimation performance, or the like, an interval between RS symbols can be increased. This is described in more detail in operation 640.

In operation 640, a combination in which a symbol is equal to or greater than a threshold interval (N_{TH}) may be extracted. According to an embodiment of the disclosure, for a symbol interval in Table 2, when a minimum threshold interval is limited to a size equivalent to four symbols, the combination may be as in Table 3 below.

TABLE 3

| 1st sym | 2nd sym | 3rd sym |
|---|---|---|
| 0 | 4 | 9 |
| 0 | 4 | 11 |
| 0 | 4 | 13 |
| 0 | 5 | 9 |
| 0 | 5 | 11 |
| 0 | 5 | 12 |
| 0 | 5 | 13 |
| 0 | 6 | 11 |
| 0 | 6 | 13 |
| 0 | 7 | 11 |
| 0 | 7 | 12 |
| 0 | 7 | 13 |
| 0 | 8 | 13 |
| 0 | 9 | 13 |
| 1 | 5 | 10 |
| 1 | 5 | 12 |
| 1 | 6 | 10 |
| 1 | 6 | 12 |
| 1 | 6 | 13 |
| 1 | 7 | 12 |
| 1 | 8 | 12 |
| 1 | 8 | 13 |
| 2 | 6 | 11 |
| 2 | 6 | 13 |
| 2 | 7 | 11 |
| 2 | 7 | 13 |
| 2 | 8 | 13 |
| 2 | 9 | 13 |
| 3 | 7 | 12 |
| 3 | 8 | 12 |
| 4 | 8 | 13 |
| 4 | 9 | 13 |

It can be identified through Table 3 that, for a symbol interval, when a minimum threshold interval is limited to four symbols, the number of combinations of positions of three RS symbols in which the maximum frequency offset is 28.03 kHz is 32.

According to an embodiment of the disclosure, when a minimum threshold interval is limited to five symbols for symbol interval in Table 2, the combination may be as in Table 4 below.

TABLE 4

| 1st sym | 2nd sym | 3rd sym |
|---|---|---|
| 0 | 5 | 11 |
| 0 | 5 | 12 |
| 0 | 5 | 13 |
| 0 | 6 | 11 |
| 0 | 6 | 13 |
| 0 | 7 | 12 |
| 0 | 7 | 13 |
| 0 | 8 | 13 |
| 1 | 6 | 12 |
| 1 | 6 | 13 |
| 1 | 7 | 12 |
| 1 | 8 | 13 |
| 2 | 7 | 13 |
| 2 | 8 | 13 |

It can be identified through Table 4 that, for a symbol interval, when a minimum threshold interval is limited to four symbols, the number of combinations of positions of three RS symbols in which the maximum frequency offset is 28.03 kHz is 14.

According to an embodiment of the disclosure, when a minimum threshold interval is limited to six symbols for symbol interval in Table 2, the combination may be as in Table 5 below.

TABLE 5

| 1st sym | 2nd sym | 3rd sym |
|---|---|---|
| 0 | 6 | 13 |
| 0 | 7 | 13 |

It can be identified through Table 5 that, for a symbol interval, when a minimum threshold interval is limited to four symbols, the number of combinations of positions of three RS symbols in which the maximum frequency offset is 28.03 kHz is 2.

As in Tables 3 to 5, when one of the combinations of RS symbols is selected and the RS symbols are arranged in consideration of a required minimum interval, a combination of RS symbols for a maximum estimable frequency offset while the channel estimation performance is improved can be found.

For example, in Section 6.4.1.1.3 of 3GPP Technical Specification (TS) 38.211, demodulation signals (DMRSs) in a slot in a wireless communication system may be arranged as in Table 6 below.

TABLE 6

| | DM-RS positions l̅ | | | | | | | |
|---|---|---|---|---|---|---|---|---|
| | PUSCH mapping type A | | | | PUSCH mapping type B | | | |
| l_{d} in | dmrs-AdditionalPosition | | | | dmrs-AdditionalPosition | | | |
| symbols | pos0 | pos1 | pos2 | pos3 | pos0 | pos1 | pos2 | pos3 |
| <4 | — | — | — | — | l₀ | l₀ | l₀ | l₀ |
| 4 | l₀ | l₀ | l₀ | l₀ | l₀ | l₀ | l₀ | l₀ |
| 5 | l₀ | l₀ | l₀ | l₀ | l₀ | l₀, 4 | l₀, 4 | l₀, 4 |
| 6 | l₀ | l₀ | l₀ | l₀ | l₀ | l₀, 4 | l₀, 4 | l₀, 4 |
| 7 | l₀ | l₀ | l₀ | l₀ | l₀ | l₀, 4 | l₀, 4 | l₀, 4 |
| 8 | l₀ | l₀, 7 | l₀, 7 | l₀, 7 | l₀ | l₀, 6 | l₀, 3, 6 | l₀, 3, 6 |
| 9 | l₀ | l₀, 7 | l₀, 7 | l₀, 7 | l₀ | l₀, 6 | l₀, 3, 6 | l₀, 3, 6 |
| 10 | l₀ | l₀, 9 | l₀, 6, 9 | l₀, 6, 9 | l₀ | l₀, 8 | l₀, 4, 8 | l₀, 3, 6, 9 |
| 11 | l₀ | l₀, 9 | l₀, 6, 9 | l₀, 6, 9 | l₀ | l₀, 8 | l₀, 4, 8 | l₀, 3, 6, 9 |
| 12 | l₀ | l₀, 9 | l₀, 6, 9 | l₀, 5, 8, 11 | l₀ | l₀, 10 | l₀, 5, 10 | l₀, 3, 6, 9 |
| 13 | l₀ | l₀, 11 | l₀, 7, 11 | l₀, 5, 8, 11 | l₀ | l₀, 10 | l₀, 5, 10 | l₀, 3, 6, 9 |
| 14 | l₀ | l₀, 11 | l₀, 7, 11 | l₀, 5, 8, 11 | l₀ | l₀, 10 | l₀, 5, 10 | l₀, 3, 6, 9 |

Referring to Table 6, it can be identified that position 1 in which physical uplink shared channel (PUSCH) DMRSs are arranged may be determined differently according to PUSCH mapping type A and PUSCH mapping type B. In addition, in Table 6, lₒ may be determined differently according to PUSCH mapping type A and PUSCH mapping type B.

The frequency offset estimation method in the disclosure can be used for the DMRS arrangement in PUSCH mapping type A when three or more DMRS symbols are arranged in one slot. According to an embodiment of the disclosure, referring to Table 6, when l_{d} in symbols is 10 to 14 and an additional position of a DMRS is pos 2 or pos 3, the frequency offset estimation method in the disclosure can be used. In addition, according to an embodiment of the disclosure, when l_{d} in symbols is 10 to 11 and an additional position of a DMRS is pos 3, the frequency offset estimation method in the disclosure can be used. According to an embodiment, in PUSCH mapping type A, lₒ may be received by higher-layer signaling, and the value of lₒ may be 2 or 3.

According to an embodiment of the disclosure, in PUSCH mapping type A, when the DMRS arrangement for a combination of three symbols is selected in Table 2, the frequency offset can be estimated as in Table 7 below.

TABLE 7

| | | | Max |
|---|---|---|---|
| 1st sym | 2nd sym | 3rd sym | FO(KHz) |
| 2 | 6 | 9 | 28.03 |
| 2 | 7 | 11 | 28.03 |
| 3 | 6 | 9 | 9.34 |
| 3 | 7 | 11 | 7.01 |

For the DMRS arrangement in PUSCH mapping type B, when three or more DMRS symbols are arranged in one slot, the frequency offset estimation method in the disclosure can be used. According to an embodiment of the disclosure, referring to Table 6, when l_{d} in symbols is 8 to 14 and an additional position of a DMRS is pos 2, the frequency offset estimation method in the disclosure can be used. In addition, according to an embodiment of the disclosure, when l_{d} in symbols is 8 to 9 and an additional position of a DMRS is pos 3, the frequency offset estimation method in the disclosure can be used. According to an embodiment, in PUSCH mapping type B, the value of lₒ may be 0.

According to an embodiment of the disclosure, in PUSCH mapping type B, when the DMRS arrangement for a combination of three symbols is selected in Table 2, the frequency offset can be estimated as in Table 8 below.

TABLE 8

| | | | Max |
|---|---|---|---|
| 1st sym | 2nd sym | 3rd sym | FO(KHz) |
| 0 | 3 | 5 | 28.03 |
| 0 | 3 | 6 | 9.34 |
| 0 | 3 | 7 | 28.03 |
| 0 | 4 | 7 | 28.03 |
| 0 | 4 | 8 | 7.01 |
| 0 | 4 | 9 | 28.03 |
| 0 | 5 | 9 | 28.03 |
| 0 | 5 | 10 | 5.61 |
| 0 | 5 | 11 | 28.03 |

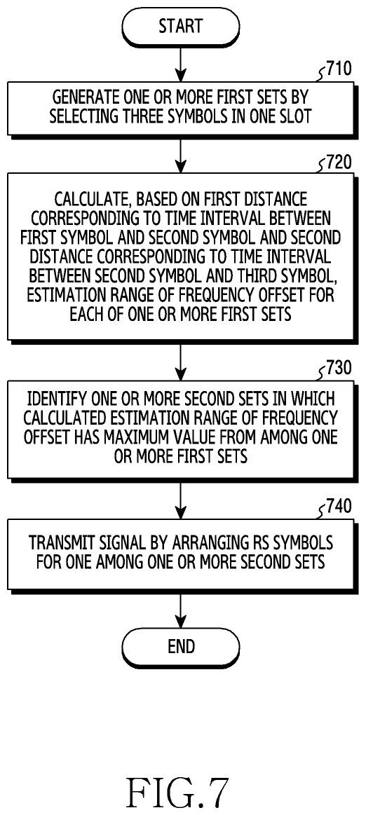

FIG. 7 is a flowchart illustrating estimation of a frequency offset by a transmission device in a wireless communication system according to an embodiment of the disclosure.

Referring to FIG. 7, in operation 710, a transmission device 110 may generate one or more first sets by selecting three symbols in one slot. The three symbols may correspond to a first symbol, a second symbol, and a three symbol, respectively, in an ascending order.

According to an embodiment, a symbol may be an OFDM symbol. In addition, according to an embodiment, the number of OFDM symbols for each symbol may be 14. In addition, according to an embodiment, for the m^{th} symbol within the OFDM symbol for each slot, m may have a value among 0 to 13.

According to an embodiment of the disclosure, when the number of OFDM symbols for each slot is assumed to be 14, the number of one or more first sets may be ₁₄C₃, i.e., 364.

In operation 720, the transmission device 110 may calculate, based on a first distance corresponding to a time interval between the first symbol and the second symbol and a second distance corresponding to a time interval between the second symbol and the third symbol, an estimation range of a frequency offset for each of the one or more first sets. The frequency offset may be calculated through discrete Fourier transform (DFT), and specifically, may be calculated through Equations 1 to 18.

According to an embodiment of the disclosure, the frequency offset of each of the one or more first sets may be calculated through discrete Fourier transform (DFT), and specifically, may be calculated based on a greatest common divisor of the first distance and the second distance. The greatest common divisor of the first distance and the second distance may be based on the linearity of the frequency offset for the first distance and the second distance.

In operation 730, the transmission device 110 may identify one or more second sets in which the estimation range of the frequency offset has a maximum value from among the one or more first sets. For the frequency offset calculated in operation 720, a frequency having a maximum value may be identified. According to an embodiment of the disclosure, when the number of OFDM symbols for each slot is assumed to be 14, referring to Table 2, the number of one or more second sets may be 267.

In operation 740, the transmission device 110 may transmit a signal by arranging RS symbols for one among the one or more second sets. The maximum frequency offset is determined by the greatest common divisor of the first distance between symbols and the second distance between symbols, and thus a wider range of frequency offsets can be estimated, compared to simply estimating a frequency offset between two RS symbols. When there are several symbol arrangement combinations achieving the maximum estimable frequency offset, one of the combinations may be selected and used in consideration of other elements such as a symbol position and a minimum symbol interval.

According to an embodiment of the disclosure, the channel estimation performance, or the like can be increased through the arrangement RS symbols, and in order to increase the channel estimation performance, or the like, an interval between RS symbols can be increased.

According to an embodiment of the disclosure, one or more third sets may be identified from the second sets through threshold distance configuration for each of the first distance and the second distance. According to an embodiment of the disclosure, referring to Table 3, the threshold distance may be a threshold distance corresponding to four or more symbols.

According to an embodiment of the disclosure, when the number of OFDM symbols for each slot is assumed to be 14 and a threshold interval is limited to four or more symbols for each of the first distance and the second distance, the number of the one or more third sets may be 32 referring to Table 3. In addition, according to an embodiment of the disclosure, when the number of OFDM symbols for each slot is assumed to be 14 and, referring to Table 4, a threshold interval is limited to five or more symbols for each of the first distance and the second distance, the number of the one or more third sets may be 14 referring to Table 5. In addition, according to an embodiment of the disclosure, when the number of OFDM symbols for each slot is assumed to be 14 and, referring to Table 6, a threshold interval is limited to six or more symbols for each of the first distance and the second distance, the number of the one or more third sets may be 2.

According to an embodiment of the disclosure, the transmission device 110 may transmit a signal by arranging RS symbols for one of the one or more third sets. The maximum frequency offset is determined by the greatest common divisor of the first distance between symbols and the second distance between symbols, and thus a wider range of frequency offsets can be estimated, compared to simply estimating a frequency offset between two RS symbols. In addition, the channel estimation performance, or the like can be increased by arranging RS symbols at wider symbol intervals.

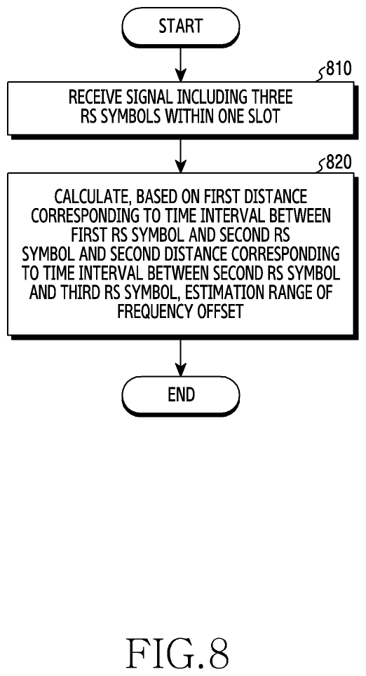

FIG. 8 is a flowchart illustrating estimation of a frequency offset by a reception device in a wireless communication system according to an embodiment of the disclosure.

Referring to FIG. 8, in operation 810, a reception device 120 may receive a signal including three RS symbols within one slot. The three RS symbols may correspond to a first symbol, a second symbol, and a third symbol, respectively, in an ascending order.

According to an embodiment, a symbol may be an OFDM symbol. In addition, according to an embodiment, the number of OFDM symbols for each symbol may be 14. In addition, according to an embodiment, for the m^{th} symbol within the OFDM symbol for each slot, m may have a value among 0 to 13.

According to an embodiment of the disclosure, when the number of OFDM symbols for each slot is assumed to be 14, the number of one or more first sets may be ₁₄C₃, i.e., 364.

In operation 820, the reception device 120 may calculate, based on a first distance corresponding to a time interval between the first RS symbol and the second RS symbol and a second distance corresponding to a time interval between the second RS symbol and the third RS symbol, an estimation range of a frequency offset for each of the one or more first sets. The frequency offset may be calculated through DFT, and specifically, may be calculated through Equations 1 to 18.

According to an embodiment of the disclosure, the frequency offset of each of the one or more first sets may be calculated through DFT, and specifically, based on Equations 1 to 18, may be calculated based on a greatest common divisor of the first distance and the second distance. The greatest common divisor of the first distance and the second distance may be based on the linearity of the frequency offset for the first distance and the second distance.

According to various embodiments of the disclosure, a method performed by a transmission device in a wireless communication system may include generating one or more first sets by selecting three symbols in one slot, wherein the three symbols correspond to a first symbol, a second symbol, and a third symbol, respectively, in an ascending order, calculating, based on a first distance corresponding to a time interval between the first symbol and the second symbol and a second distance corresponding to a time interval between the second symbol and the third symbol, an estimation range of a frequency offset for each of the one or more first sets identifying one or more second sets in which the calculated estimation range of the frequency offset has a maximum value from among the one or more first sets, and transmitting a signal by arranging reference signal (RS) symbols for one among the one or more second sets.

According to an embodiment of the disclosure, the transmitting of the signal by arranging the reference signal (RS) symbols for one among the one or more second sets may include identifying one or more third sets in which each of the first distance and the second distance exceeds a third distance corresponding to a threshold distance from among the one or more second sets, and transmitting, based on the one or more third sets, a signal.

According to an embodiment of the disclosure, wherein the calculating of the estimation range of the frequency offset may include calculating a greatest common divisor of the first distance and the second distance, and calculating, based on the greatest common divisor, the estimation range of the frequency offset.

According to an embodiment of the disclosure, the estimation range of the frequency offset may be determined based on the greatest common divisor and a subcarrier spacing (SCS) of the signal.

According to an embodiment of the disclosure, the first distance may include a first sample distance, and the second distance may include a second sample distance.

According to an embodiment of the disclosure, the third distance may correspond to a pre-configured symbol distance.

According to an embodiment of the disclosure, the first distance may be different from the second distance.

According to various embodiments of the disclosure, a method performed by a reception device in a wireless communication system may include receiving a signal including three reference signal (RS) symbols in one slot, wherein the three RS symbols correspond to a first RS symbol, a second RS symbol, and a third RS symbol, respectively, in an ascending order, and calculating, based on a first distance corresponding to a time interval between the first RS symbol and the second RS symbol and a second distance corresponding to a time interval between the second RS symbol and the third RS symbol, an estimation range of a frequency offset.

According to an embodiment of the disclosure, the calculating of the estimation range of the frequency offset may include calculating a greatest common divisor of the first distance and the second distance, and calculating, based on the greatest common divisor, the estimation range of the frequency offset.

According to an embodiment of the disclosure, the estimation range of the frequency offset may be determined based on the greatest common divisor and a subcarrier spacing (SCS) of the signal.

According to various embodiments of the disclosure, a transmission device in a wireless communication system may include a communication unit and a controller connected to the communication unit, wherein the controller is configured to generate one or more first sets by selecting three symbols in one slot, wherein the three symbols correspond to a first symbol, a second symbol, and a third symbol, respectively, in an ascending order, calculate, based on a first distance corresponding to a time interval between the first symbol and the second symbol and a second distance corresponding to a time interval between the second symbol and the third symbol, an estimation range of a frequency offset for each of the one or more first sets, identify one or more second sets in which the calculated estimation range of the frequency offset has a maximum value from among the one or more first sets, and transmit a signal by arranging reference signal (RS) symbols for one among the one or more second sets.

According to various embodiments of the disclosure, a reception device in a wireless communication system may include a communication unit and a controller connected to the communication unit, wherein the controller is configured to receive a signal including three reference signal (RS) symbols in one slot, wherein the three RS symbols correspond to a first RS symbol, a second RS symbol, and a third RS symbol, respectively, in an ascending order, and calculate, based on a first distance corresponding to a time interval between the first RS symbol and the second RS symbol and a second distance corresponding to a time interval between the second RS symbol and the third RS symbol, an estimation range of a frequency offset.

It should be appreciated that the embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., a program) including one or more instructions that are stored in a storage medium (e.g., internal memory or external memory) that is readable by a machine (e.g., an electronic device). For example, a processor of the machine (e.g., an electronic device) may invoke at least one of the one or more instructions stored in the storage medium, and execute it. This allows the machine to be operated to perform at least one function according to the at least one instruction invoked. The one or more instructions each may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a transmission device in a wireless communication system, the method comprising:
generating one or more first sets by selecting three symbols in one slot, the three symbols corresponding to a first symbol, a second symbol, and a third symbol, respectively, in an ascending order;
for each of the one or more first sets, calculating an estimation range of a frequency offset, based on a first distance corresponding to a time interval between the first symbol and the second symbol and a second distance corresponding to a time interval between the second symbol and the third symbol;
identifying, from among the one or more first sets, one or more second sets in which the calculated estimation range of the frequency offset is greatest; and
transmitting a signal by arranging reference signal (RS) symbols for one of the one or more second sets.

2. The method of claim 1, wherein the transmitting of the signal by arranging the reference signal (RS) symbols for one of the one or more second sets comprises:
identifying, from among the one or more second sets, one or more third sets in which each of the first distance and the second distance exceeds a third distance corresponding to a threshold distance; and
based on the one or more third sets, transmitting a signal.

3. The method of claim 1, wherein the calculating of the estimation range of the frequency offset comprises:
calculating a greatest common divisor of the first distance and the second distance; and
based on the greatest common divisor, calculating the estimation range of the frequency offset.

4. The method of claim 3, wherein the estimation range of the frequency offset is determined based on the greatest common divisor and a subcarrier spacing (SCS) of the signal.

5. The method of claim 1,
wherein the first distance comprises a first sample distance, and
wherein the second distance comprises a second sample distance.

6. The method of claim 2,
wherein the third distance corresponds to a pre-configured symbol distance, and
wherein the first distance is different from the second distance.

7. A method performed by a reception device in a wireless communication system, the method comprising:
receiving a signal comprising three reference signal (RS) symbols in one slot, the three RS symbols corresponding to a first RS symbol, a second RS symbol, and a third RS symbol, respectively, in an ascending order; and
based on a first distance corresponding to a time interval between the first RS symbol and the second RS symbol and a second distance corresponding to a time interval between the second RS symbol and the third RS symbol, calculating an estimation range of a frequency offset.

8. The method of claim 7,
wherein the calculating of the estimation range of the frequency offset comprises:
calculating a greatest common divisor of the first distance and the second distance; and
based on the greatest common divisor, calculating the estimation range of the frequency offset, and
wherein the estimation range of the frequency offset is determined based on the greatest common divisor and a subcarrier spacing (SCS) of the signal.

9. A transmission device in a wireless communication system, the transmission device comprising:
a transceiver;
a processor; and
memory storing instructions that, when executed by the processor, cause the transmission device to:
generate one or more first sets by selecting three symbols in one slot, the three symbols corresponding to a first symbol, a second symbol, and a third symbol, respectively, in an ascending order,
for each of the one or more first sets, calculate an estimation range of a frequency offset, based on a first distance corresponding to a time interval between the first symbol and the second symbol and a second distance corresponding to a time interval between the second symbol and the third symbol,
identify, from among the one or more first sets, one or more second sets in which the calculated estimation range of the frequency offset is greatest, and
transmit a signal by arranging reference signal (RS) symbols for one of the one or more second sets.

10. The transmission device of claim 9, wherein the memory further comprises the instructions that, when executed by the processor, cause the transmission device to, in order to transmit the signal by arranging the reference signal (RS) symbols for one of the one or more second sets:
identify, from among the one or more second sets, one or more third sets in which each of the first distance and the second distance exceeds a third distance corresponding to a threshold distance, and
based on the one or more third sets, transmit a signal.

11. The transmission device of claim 9, wherein the memory further comprises the instructions that, when executed by the processor, cause the transmission device to, in order to calculate the estimation range of the frequency offset:
calculate a greatest common divisor of the first distance and the second distance, and
based on the greatest common divisor, calculate the estimation range of the frequency offset, and
wherein the estimation range of the frequency offset is determined based on the greatest common divisor and a subcarrier spacing (SCS) of the signal.

12. The transmission device of claim 9,
wherein the first distance comprises a first sample distance, and
wherein the second distance comprises a second sample distance.

13. The transmission device of claim 10,
wherein the third distance corresponds to a pre-configured symbol distance, and
wherein the first distance is different from the second distance.

14. A reception device in a wireless communication system, the reception device comprising:
a transceiver;
a processor; and
memory storing instructions that, when executed by the processor, cause the reception device to:
receive a signal comprising three reference signal (RS) symbols in one slot, the three RS symbols corresponding to a first RS symbol, a second RS symbol, and a third RS symbol, respectively, in an ascending order, and
based on a first distance corresponding to a time interval between the first RS symbol and the second RS symbol and a second distance corresponding to a time interval between the second RS symbol and the third RS symbol, calculate an estimation range of a frequency offset.

15. The reception device of claim 14,
wherein the memory further comprises the instructions that, when executed by the processor, cause the reception device to, in order to calculate the estimation range of the frequency offset:
calculate a greatest common divisor of the first distance and the second distance; and
based on the greatest common divisor, calculate the estimation range of the frequency offset, and
wherein the estimation range of the frequency offset is determined based on the greatest common divisor and a subcarrier spacing (SCS) of the signal.

16. One or more non-transitory computer-readable storage media storing one or more computer programs including computer-executable instructions that, when executed by one or more processors of a transmission device in a wireless communication system individually or collectively, cause the transmission device to perform operations, the operations comprising:
generating one or more first sets by selecting three symbols in one slot, the three symbols corresponding to a first symbol, a second symbol, and a third symbol, respectively, in an ascending order;
for each of the one or more first sets, calculating an estimation range of a frequency offset, based on a first distance corresponding to a time interval between the first symbol and the second symbol and a second distance corresponding to a time interval between the second symbol and the third symbol;
identifying, from among the one or more first sets, one or more second sets in which the calculated estimation range of the frequency offset is greatest; and
transmitting a signal by arranging reference signal (RS) symbols for one of the one or more second sets.

17. The one or more non-transitory computer-readable storage media of claim 16, wherein the transmitting of the signal by arranging the reference signal (RS) symbols for one of the one or more second sets comprises:
identifying, from among the one or more second sets, one or more third sets in which each of the first distance and the second distance exceeds a third distance corresponding to a threshold distance; and
based on the one or more third sets, transmitting a signal.

18. The one or more non-transitory computer-readable storage media of claim 16, wherein the calculating of the estimation range of the frequency offset comprises:
calculating a greatest common divisor of the first distance and the second distance; and
based on the greatest common divisor, calculating the estimation range of the frequency offset.

19. The one or more non-transitory computer-readable storage media of claim 18, wherein the estimation range of the frequency offset is determined based on the greatest common divisor and a subcarrier spacing (SCS) of the signal.

20. The one or more non-transitory computer-readable storage media of claim 16,
wherein the first distance comprises a first sample distance, and
wherein the second distance comprises a second sample distance.
